(19) United States
(12) Patent Application Publication
(10) Pub. No.: US 2026/0187536 A1
(43) Pub. Date: Jul. 2, 2026

(54) UNCERTAINTY LEARNING DEVICE, STORAGE MEDIUM STORING UNCERTAINTY LEARNING PROGRAM, AND UNCERTAINTY LEARNING SYSTEM

(71) Applicant: Mitsubishi Electric Corporation, Tokyo (JP)

(72) Inventors: Koki NAKANE, Tokyo (JP); Kenya SUGIHARA, Tokyo (JP); Shotaro AKAHO, Tsukuba-shi Ibaraki (JP); Hideki ASOH, Tsukuba-shi Ibaraki (JP)

(73) Assignee: Mitsubishi Electric Corporation, Tokyo (JP)

(21) Appl. No.: 19/545,801

(22) Filed: Feb. 20, 2026

Related U.S. Application Data
(63) Continuation of application No. PCT/JP2024/024861, filed on Jul. 10, 2024.

(30) Foreign Application Priority Data
Oct. 26, 2023 (JP) 2023-183611

(51) Int. Cl. G06N 20/00

(52) U.S. Cl. CPC G06N 20/00

(57) ABSTRACT

Included are: a training data acquiring unit that acquires training data created on the basis of operation-related data obtained from a machine device; a noise imparting unit that creates noise-imparted training data in which noise is imparted to the training data acquired by the training data acquiring unit; an outlier detecting unit that calculates an outlier score from the training data acquired by the training data acquiring unit and the noise-imparted training data created by the noise imparting unit; and a model learning unit that calculates a weighted loss function based on the outlier score calculated by the outlier detecting unit, and trains a machine learning model on the basis of the training data and the noise-imparted training data.

### CROSS REFERENCE TO RELATED APPLICATIONS

This application is a Continuation of PCT International Application No. PCT/JP2024/024861, filed on Jul. 10, 2024, which claims priority to Japanese Patent Application No. 2023-183611, filed in Japan on Oct. 26, 2023, all of which are hereby expressly incorporated by reference into the present application.

### TECHNICAL FIELD

The present disclosure relates to an uncertainty learning device, a storage medium storing an uncertainty learning program, and an uncertainty learning system that create a learned model (hereinafter, referred to as a “machine learning model”) that outputs a predicted value and uncertainty for input data.

### BACKGROUND ART

In recent years, a technique for solving various tasks using a machine learning model is known in various scenes.

For example, when an application of the machine learning model to a machine device such as an automatic driving device, a device used in a life-threatening scene such as a medical site, or a factory automation (FA) device is considered, the machine learning model outputs some data even when any data is input. It is conceivable that the machine learning model sometimes outputs an output result unexpected by a human, in other words, an output result with low reliability. If the output result with low reliability output by the machine learning model is used as it is for control of a machine device, there is a possibility of an unexpected situation arising.

Therefore, conventionally, a technique for inferring how much uncertainty is included in an output itself of a machine learning model is known. Here, the uncertainty is reliability.

For example, Non-Patent Literature 1 discloses a technique that expresses how much uncertainty is included in an output itself of a machine learning model by the magnitude of a width, in which the width of uncertainty output by the machine learning model for data that is not learned (extrapolation data) increases by adding noise to training data of the machine learning model.

### CITATION LIST

### Non-Patent Literature

Non-Patent Literature 1: Danijar Hafner, Noise Contrastive Priors for Functional Uncertainty, 1 Jul. 2019

### SUMMARY OF INVENTION

### Technical Problem

In a conventional technique that outputs uncertainty, represented by the technique disclosed in Non-Patent Literature 1, since a machine learning model is trained by imparting noise to all pieces of training data, there is a problem that even when data close to the training data is input and a good predicted value is output at the time of inference using the machine learning model, uncertainty output together with the predicted value may increase.

The present disclosure has been made in order to solve the problem, and an object of the present disclosure is to provide a machine learning model capable of inferring a predicted value and uncertainty, and capable of inferring uncertainty more accurately as compared with a machine learning model created by a conventional method for learning a machine learning model by imparting noise to all pieces of training data.

### Solution to Problem

An uncertainty learning device according to the present disclosure is an uncertainty learning device that creates a machine learning model that receives, as an input, data based on operation-related data related to an operation result of a machine device and outputs a predicted value corresponding to the operation-related data and uncertainty of the predicted value, the uncertainty learning device including: a processor; and a memory storing a program, upon executed by the processor, to perform a process: to acquire training data created on the basis of the operation-related data obtained from the machine device; to create noise-imparted training data in which noise is imparted to the training data acquired; to calculate an outlier score from the training data acquired and the noise-imparted training data created; and to calculate a weighted loss function based on the outlier score calculated, and to train the machine learning model on the basis of the training data and the noise-imparted training data.

### Advantageous Effects of Invention

According to the present disclosure, with the above configuration, it is possible to provide a machine learning model capable of inferring uncertainty more accurately as compared with a machine learning model created by a conventional method for training a machine learning model by imparting noise to all pieces of training data.

### BRIEF DESCRIPTION OF DRAWINGS

FIGS. 1A, 1B, and 1C are diagrams for describing types of uncertainty inferred by a machine learning model and an example of inference of ideal uncertainty performed by the machine learning model, in which FIG. 1A is a diagram for describing uncertainty of a problem, FIG. 1B is a diagram for describing uncertainty of learning, and FIG. 1C is a diagram for describing ideal uncertainty.

FIG. 2 is a diagram for describing in more detail a problem of a conventional technique to be solved by an uncertainty learning device according to a first embodiment.

FIG. 3 is a diagram illustrating a configuration example of an uncertainty learning system including the uncertainty learning device according to the first embodiment.

FIG. 4 is a flowchart for describing learning-time operation of the uncertainty learning device according to the first embodiment.

FIG. 5 is a flowchart for describing details of processing of step ST3 in FIG. 4.

FIG. 6 is a flowchart for describing inference-time operation of the uncertainty learning device according to the first embodiment.

FIGS. 7A and 7B are each a diagram illustrating an example of a hardware configuration of the uncertainty learning device according to the first embodiment.

FIG. 8 is a diagram illustrating a configuration example of an uncertainty learning system including an uncertainty learning device according to a second embodiment.

FIG. 9 is a flowchart for describing learning-time operation of the uncertainty learning device according to the second embodiment.

FIG. 10 is a flowchart for describing inference-time operation of the uncertainty learning device according to the second embodiment.

FIG. 11 is a diagram illustrating a configuration example of an uncertainty learning system including an uncertainty learning device according to a third embodiment.

FIGS. 12A, 12B, and 12C are diagrams for describing an example of transfer learning, in which FIG. 12A is a diagram illustrating an example of Fine Tuning, FIG. 12B is a diagram illustrating an example of Feature Extraction, and FIG. 12C is a diagram illustrating an example of Joint Training.

FIG. 13 is a flowchart for describing learning-time operation of the uncertainty learning device according to the third embodiment.

FIG. 14 is a flowchart for describing details of processing of step ST3a in FIG. 13.

FIG. 15 is a diagram illustrating a configuration example of an uncertainty learning system including an uncertainty learning device according to a fourth embodiment.

FIG. 16 is a flowchart for describing operation of the uncertainty learning device according to the fourth embodiment.

### DESCRIPTION OF EMBODIMENTS

Hereinafter, in order to describe the present disclosure in more detail, embodiments for carrying out the present disclosure will be described with reference to the attached drawings.

### First Embodiment

An uncertainty learning device according to a first embodiment creates a learned model (hereinafter, referred to as a “machine learning model”).

The machine learning model outputs a value of prediction (hereinafter, referred to as a “predicted value”) and uncertainty on the basis of input data. The uncertainty is an index indicating the degree of reliability of prediction of how much the machine learning model has confidence in the predicted value. When the uncertainty is high, it means that the machine learning model does not have confidence in the predicted value, in other words, the reliability of the predicted value is low. On the other hand, when the uncertainty is low, it can be interpreted that the machine learning model has high confidence in the predicted value, in other words, the reliability of the predicted value is high. It is important for a user or the like to know uncertainty for the predicted value output by the machine learning model in order to perform appropriate processing. By using information of uncertainty, the user or the like can evaluate a risk of prediction performed by the machine learning model and can make a more careful decision.

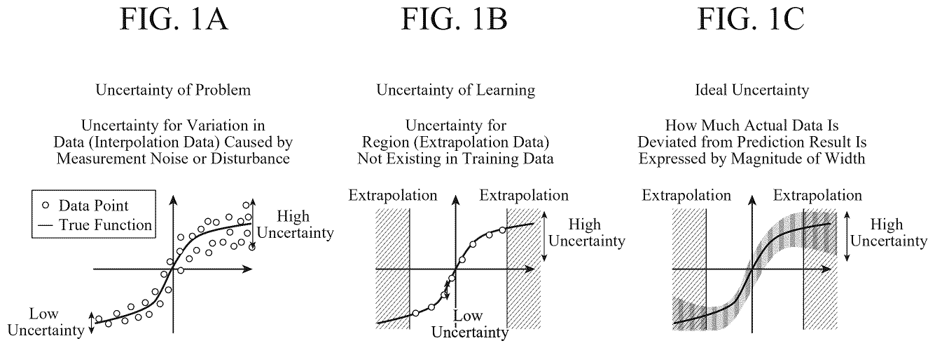

Here, FIG. 1 is a diagram for describing types of uncertainty inferred by the machine learning model and an example of inference of ideal uncertainty performed by the machine learning model.

Examples of the uncertainty for the predicted value include uncertainty for a variation in data (hereinafter, referred to as “interpolation data”) existing in training data and caused by measurement noise or disturbance (see FIG. 1A) and uncertainty for data (hereinafter, referred to as “extrapolation data”) not existing in the training data (see FIG. 1B).

It is required to construct a machine learning model capable of accurately outputting uncertainty for both uncertainty due to a variation in the interpolation data, in other words, uncertainty of a problem and uncertainty for the extrapolation data, in other words, uncertainty of learning (see FIG. 1C).

Therefore, for example, in the conventional technique as disclosed in Non-Patent Literature 1 described above, noise is imparted to training data, and learning is performed so that uncertainty increases, in other words, reliability decreases for the training data to which the noise is imparted.

However, in the conventional technique, since the machine learning model is trained by imparting noise, the machine learning model can output uncertainty of learning with a certain degree of accuracy, but there is a problem that there is a possibility that uncertainty of a problem cannot be accurately output.

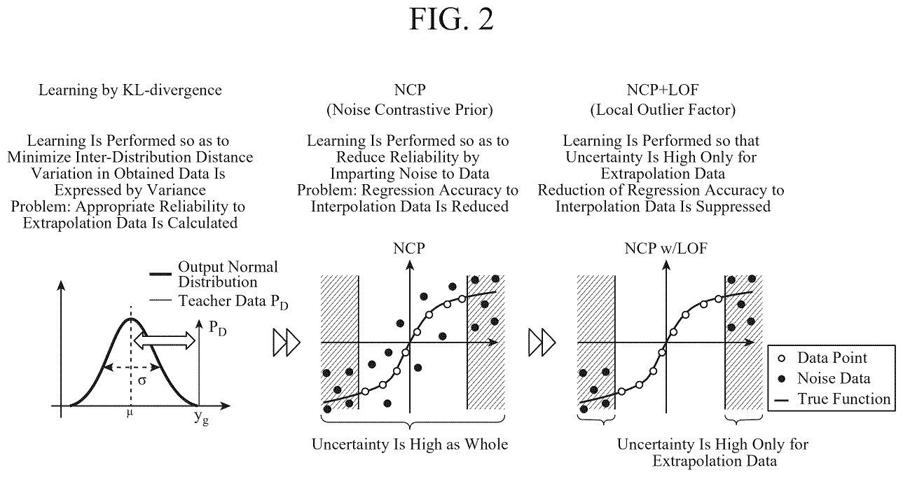

FIG. 2 is a diagram for describing in more detail a problem of the conventional technique to be solved by the uncertainty learning device according to the first embodiment.

For example, when the machine learning model is learned so as to output uncertainty by expressing a variation in the interpolation data by a variance using a KL-divergence method, uncertainty of a problem can be output with a certain degree of accuracy. However, in learning using this method, it is difficult to appropriately infer uncertainty for the extrapolation data (see the left diagram in FIG. 2). This is because the extrapolation data is out of the range of the training data, and thus a large difference from a true distribution may be generated. Since the machine learning model is trained on the basis of the training data, there is a problem that it is difficult to infer accurate uncertainty for data (extrapolation data) outside the range of the training data.

On the other hand, in the conventional technique as disclosed in Non-Patent Literature 1 described above, by imparting noise to training data, learning is performed so that uncertainty increases for the training data to which the noise is imparted (see the middle diagram in FIG. 2). Therefore, the conventional technique can solve the problem that it is difficult to infer accurate uncertainty for the extrapolation data as described above.

However, in the conventional technique, a machine learning model is trained by imparting noise to all pieces of training data. Therefore, even when data close to the training data is input and a good predicted value is output at the time of inference using the machine learning model, there is a possibility that uncertainty to be output together with the predicted value increases. That is, in the conventional technique, there is a possibility that uncertainty of a problem cannot be accurately output.

The uncertainty learning device according to the first embodiment solves the problem of the conventional technique, and provides a machine learning model capable of accurately inferring uncertainty for both uncertainty of a problem and uncertainty of learning, that is, for both uncertainty of interpolation data and uncertainty of extrapolation data.

Specifically, the uncertainty learning device according to the first embodiment trains the machine learning model so as to infer uncertainty using a result of inferring how much the noise-imparted training data is deviated by an outlier detecting mechanism (see the right diagram in FIG. 2). Details of a configuration and an operation of the uncertainty learning device will be described later.

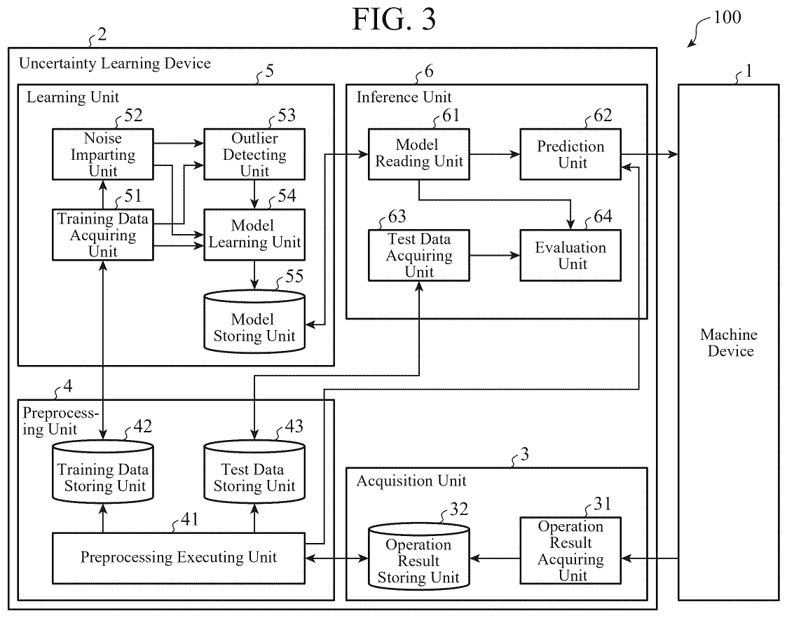

FIG. 3 is a diagram illustrating a configuration example of an uncertainty learning system 100 including an uncertainty learning device 2 according to the first embodiment.

The uncertainty learning system 100 includes the uncertainty learning device 2 and a machine device 1. The uncertainty learning device 2 and the machine device 1 are connected to each other via a network.

In the first embodiment, the machine device 1 is assumed to be, for example, a factory automation (FA) device. The FA device includes, for example, a servomotor, a CNC, a processing machine such as a sheet metal laser processing machine or an electrical discharge processing machine, and a robot.

The uncertainty learning device 2 is included in, for example, a server.

In the first embodiment, the uncertainty learning device 2 performs “learning” of creating a machine learning model and “inference” of inferring a predicted value and uncertainty using the machine learning model created by “learning”. Details of processing of “learning” and details of processing of “inference” will be described later.

The uncertainty learning device 2 includes an acquisition unit 3, a preprocessing unit 4, a learning unit 5, and an inference unit 6.

The acquisition unit 3 includes an operation result acquiring unit 31 and an operation result storing unit 32.

The preprocessing unit 4 includes a preprocessing executing unit 41, a training data storing unit 42, and a test data storing unit 43.

The learning unit 5 includes a training data acquiring unit 51, a noise imparting unit 52, an outlier detecting unit 53, a model learning unit 54, and a model storing unit 55.

The inference unit 6 includes a model reading unit 61, a prediction unit 62, a test data acquiring unit 63, and an evaluation unit 64.

At the time of learning, in the uncertainty learning device 2, among the above components, the operation result acquiring unit 31, the preprocessing executing unit 41, the training data acquiring unit 51, the noise imparting unit 52, the outlier detecting unit 53, the model learning unit 54, the model reading unit 61, the test data acquiring unit 63, and the evaluation unit 64 function.

At the time of inference, in the uncertainty learning device 2, among the above components, the operation result acquiring unit 31, the preprocessing executing unit 41, the model reading unit 61, and the prediction unit 62 function.

The operation result acquiring unit 31 of the acquisition unit 3 acquires data (hereinafter, referred to as “operation-related data”) regarding an operation result of the machine device 1 from the machine device 1.

The operation result includes, for example, a parameter set in the machine device 1, a configuration of the machine device 1, an operation mode thereof, data indicating a value unique to the machine device 1, and log data operated by the machine device 1. Note that the operation result acquiring unit 31 acquires the operation-related data from the machine device 1 via, for example, an encoder (not illustrated).

Here, the operation result acquiring unit 31 acquires the operation-related data related to an operation result of an FA device from the FA device. For example, when the FA device is a computer numerical control (CNC) processing machine, the operation-related data includes a command position, a command speed, a command acceleration, a feedback speed, a feedback acceleration, and a current value. The operation-related data may include, for example, a value obtained by measuring a deviation of a processing position.

In the following first embodiment, the machine device 1 refers to an FA device.

The operation result acquiring unit 31 directly acquires, for example, values measured by various sensors arranged in the machine device 1 as the operation-related data. Examples of the various sensors include a speed sensor, an acceleration sensor, a gyro sensor, a temperature sensor, and a humidity sensor. In addition, the operation result acquiring unit 31 may acquire, for example, a value calculated on the basis of values measured by various sensors arranged in the machine device 1 as the operation-related data.

The operation result acquiring unit 31 causes the operation result storing unit 32 to store the acquired operation-related data. For example, the operation result acquiring unit 31 imparts an acquisition date and time of the operation-related data to the operation-related data and causes the operation result storing unit 32 to store the operation-related data.

The operation result storing unit 32 stores the operation-related data acquired by the operation result acquiring unit 31.

Note that, here, the operation result storing unit 32 is included in the uncertainty learning device 2, but this is merely an example. The operation result storing unit 32 may be disposed at a place that can be referred to by the uncertainty learning device 2 outside the uncertainty learning device 2.

The preprocessing executing unit 41 of the preprocessing unit 4 acquires the operation-related data acquired by the operation result acquiring unit 31 from the operation result storing unit 32, and performs preprocessing of shaping various data on the basis of the operation-related data.

In the first embodiment, the preprocessing performed by the preprocessing executing unit 41 includes preprocessing when the uncertainty learning device 2 creates a machine learning model and preprocessing when the uncertainty learning device 2 performs inference for obtaining a predicted value and uncertainty using the created machine learning model.

In the first embodiment, the preprocessing performed by the preprocessing executing unit 41 when the uncertainty learning device 2 creates a machine learning model is also referred to as “learning-time preprocessing”, and the preprocessing performed by the preprocessing executing unit 41 when the uncertainty learning device 2 performs inference is also referred to as “inference-time preprocessing”. Note that, in the uncertainty learning device 2, the machine learning model is created by the learning unit 5 and the evaluation unit 64 of the inference unit 6, and the inference using the machine learning model is performed by the prediction unit 62 of the inference unit 6. Details of the learning unit 5 and the inference unit 6 will be described later.

Hereinafter, the learning-time preprocessing and the inference-time preprocessing performed by the preprocessing executing unit 41 will be described.

First, the learning-time preprocessing performed by the preprocessing executing unit 41 will be described.

The preprocessing executing unit 41 acquires the operation-related data acquired by the operation result acquiring unit 31 from the operation result storing unit 32, and performs preprocessing of shaping training data used by the learning unit 5 and test data used by the evaluation unit 64 of the inference unit 6, that is, the learning-time preprocessing, on the basis of the operation-related data.

In the first embodiment, the learning-time preprocessing performed by the preprocessing executing unit 41 includes, for example, processing of dividing data included in the operation-related data into an explanatory variable and an objective variable, processing of transforming data included in the operation-related data into a feature necessary for learning of a machine learning model, and processing of dividing the operation-related data into training data and test data.

Here, the explanatory variable and the objective variable will be described.

What kind of data is used as the explanatory variable and the objective variable is determined in advance by a user or the like.

At least one piece of data other than the objective variable is used as the explanatory variable.

For example, when a deviation of a processing position is used as the objective variable, operation-related data indicating the processing position or a speed can be the explanatory variable.

At least one piece of data desired to be predicted with a machine learning model is used as the objective variable. A user or the like may appropriately change the objective variable depending on a problem, a numerical value is used as the objective variable in a case of a regression problem, and a class desired to be classified is used as the objective variable in a case of a classification problem.

For example, when it is desired to predict a deviation of a processing position due to friction or the like in the machine device 1, the user or the like only needs to use a value obtained by measuring the deviation of the processing position as the objective variable.

Next, the transformation of the feature in the learning-time preprocessing performed by the preprocessing executing unit 41 will be described with an example.

The preprocessing executing unit 41 may transform the explanatory variable in order to create a feature effective for learning. For example, the preprocessing executing unit 41 may transform the explanatory variable by applying standardization for transforming a scale of a variable, linear transformation of Min-Max scaling, or nonlinear transformation such as Box-Cox, or may transform the explanatory variable by applying One-hot encoding embedding, or the like when a part of data is a category variable.

Next, division of the training data and the test data in the learning-time preprocessing performed by the preprocessing executing unit 41 will be described with an example.

When learning is performed, data included in the operation-related data needs to be divided into training data used for learning and test data for evaluating performance of the trained machine learning model.

For example, the preprocessing executing unit 41 may randomly divide data included in the operation-related data into training data and test data, or may create training data by equalizing the number of pieces of data for each class like a classification problem and divide the remaining data into test data.

Note that, when the operation-related data is time series data, if new data is learned in a time direction, correct data for old data is learned, and data leakage occurs, and therefore the preprocessing executing unit 41 needs to separate the training data and the test data from each other with attention to a time axis.

The preprocessing executing unit 41 causes the training data storing unit 42 to store the training data created by performing the learning-time preprocessing. In addition, the preprocessing executing unit 41 causes the test data storing unit 43 to store the test data created by performing the learning-time preprocessing.

Next, the inference-time preprocessing performed by the preprocessing executing unit 41 will be described.

The preprocessing executing unit 41 acquires the operation-related data acquired by the operation result acquiring unit 31 from the operation result storing unit 32, and performs preprocessing of shaping data (hereinafter, referred to as “model input data”) used by the prediction unit 62 of the inference unit 6, that is, the inference-time preprocessing, on the basis of the operation-related data.

In the first embodiment, the inference-time preprocessing performed by the preprocessing executing unit 41 includes, for example, processing of using data that is an explanatory variable among pieces of data included in the operation-related data as the model input data, and processing of transforming data included in the operation-related data into a feature necessary as the model input data of a machine learning model.

The preprocessing executing unit 41 only needs to perform transformation into a feature necessary as the model input data of the machine learning model by the same method as the feature transforming method for transforming an explanatory variable in order to create a feature effective for learning in the learning-time preprocessing.

Note that, in inference using the machine learning model, the data does not need to be divided into training data and test data.

The preprocessing executing unit 41 outputs the model input data created by performing the inference-time preprocessing to the prediction unit 62.

The training data storing unit 42 of the preprocessing unit 4 stores the training data.

Note that, here, the training data storing unit 42 is included in the uncertainty learning device 2, but this is merely an example. The training data storing unit 42 may be disposed at a place that can be referred to by the uncertainty learning device 2 outside the uncertainty learning device 2.

The test data storing unit 43 of the preprocessing unit 4 stores the test data.

Note that, here, the test data storing unit 43 is included in the uncertainty learning device 2, but this is merely an example. The test data storing unit 43 may be disposed at a place that can be referred to by the uncertainty learning device 2 outside the uncertainty learning device 2.

The learning unit 5 creates a machine learning model on the basis of the training data stored in the training data storing unit 42.

One or more machine learning methods such as a neural network are used as the machine learning model. The neural network may be of any type such as a hierarchical neural network, a convolutional neural network, or a recursive neural network. The number of outputs of the neural network only needs to be at least two so that a predicted value and uncertainty can be output.

Note that when the number of dimensions of input data of the machine learning model, such as the number of parameters, increases, the learning unit 5 may reduce the dimensions of the input data using various dimension reducing methods and use the data obtained by reducing the dimensions as the input data of the machine learning model. Examples of the various dimension reducing methods include principal component analysis, singular value analysis, tensor analysis, and Auto Encoder. Since these dimension reducing methods are known methods, detailed description thereof is omitted.

The training data acquiring unit 51 of the learning unit 5 acquires the training data from the training data storing unit 42.

Regarding the training data, N pieces of training data are stored in the training data storing unit 42. In this case, when an explanatory variable is represented by xn and an objective variable is represented by yn for the N pieces of training data, the training data can be expressed by D_{N}={{x₁,y₁}, . . . , {xₙ,yₙ}}. The learning unit 5 trains the machine learning model for the training data D_{N}. Note that the machine learning model is trained by the model learning unit 54 of the learning unit 5. Details of the model learning unit 54 will be described later.

The training data acquiring unit 51 outputs the acquired training data to the noise imparting unit 52, the outlier detecting unit 53, and the model learning unit 54.

The noise imparting unit 52 of the learning unit 5 creates data (hereinafter, referred to as “noise-imparted training data”) in which noise is imparted to the training data acquired by the training data acquiring unit 51.

For example, the noise imparting unit 52 creates the noise-imparted training data by adding a value created from a Gaussian distribution, a uniform distribution, a gamma distribution, or a R distribution to the explanatory variable and the objective variable of the training data.

For example, in a case where the noise imparting unit 52 creates the noise-imparted training data by adding a value created from a Gaussian distribution, when an explanatory variable is represented by x and an objective variable is represented by y,
an explanatory variable \hat{x} after noise impartment and an objective variable ŷ after noise impartment are calculated by

$$\hat{x} = x + N ( {μ}_{x} , {σ}_{x} )$$

$$\hat{y} = N ( {μ}_{y} , {σ}_{y} )$$

At this time,
N(⋅): Gaussian distribution,
μₓ, σₓ: average value and standard deviation of noise added to an explanatory variable,
μ_{y}, σ_{y}: average value and standard deviation of noise added to an objective variable.

Note that μ_{y} may satisfy μ_{y}=y.

For example, when a variation in the explanatory variable or the objective variable is known from characteristics of the machine device 1, the noise imparting unit 52 only needs to impart noise simulating the variation.

The noise imparting unit 52 outputs the noise-imparted training data to the outlier detecting unit 53 and the model learning unit 54.

Note that the noise imparting unit 52 may create the noise-imparted training data by imparting noise to all pieces of the training data acquired by the training data acquiring unit 51 from the training data storing unit 42, or may create the noise-imparted training data by imparting noise to some pieces (mini-batch) of the training data acquired by the training data acquiring unit 51 from the training data storing unit 42.

The outlier detecting unit 53 of the learning unit 5 calculates an outlier score from the training data acquired by the training data acquiring unit 51 and the noise-imparted training data created by the noise imparting unit 52.

Calculation of an outlier score performed by the outlier detecting unit 53 will be described in detail.

First, the outlier detecting unit 53 inputs the training data acquired by the training data acquiring unit 51 to the outlier detecting mechanism and learns the training data.

Note that, for example, the outlier detecting unit 53 inputs all pieces of the training data acquired by the training data acquiring unit 51 to the outlier detecting mechanism and learns all pieces of the training data.

The outlier detecting unit 53 only needs to learn the training data using a known outlier detecting mechanism such as Hotelling's theory, k-nearest neighbor algorithm, Local Outlier Factor (LOF), or One class Support Vector Machine. The outlier detecting unit 53 may use one or more of these known outlier detecting mechanisms.

In addition, when the number of dimensions to be input is large, the outlier detecting unit 53 may reduce the dimensions of the input data using the above-described known dimension reducing method, and may use data with the reduced dimensions as an input of the outlier detecting mechanism.

The input data to be input to the outlier detecting mechanism by the outlier detecting unit 53 may be, for example, all or some of the explanatory variables included in the training data, or may be data obtained by adding the objective variable to all or some of the explanatory variables included in the training data.

After learning the outlier detecting mechanism using all pieces of the training data, next, the outlier detecting unit 53 inputs the noise-imparted training data created by the noise imparting unit 52 to the learned outlier detecting mechanism, and calculates an outlier score.

Then, the outlier detecting unit 53 sets a weight γ of NCP Loss from the calculated outlier score. In the first embodiment, a second term in a loss function used in learning of the machine learning model is referred to as “NCP Loss”. Details of the loss function will be described later.

The outlier detecting unit 53 sets the weight γ of NCP Loss, for example, according to the magnitude of the outlier score calculated by the outlier detecting mechanism.

The outlier detecting unit 53 sets the weight γ so that the weight γ is large for the noise-imparted training data deviated from the training data, and sets the weight γ so that the weight γ is small for the noise-imparted training data close to the training data. For example, when the outlier score is calculated by known LOF which is an outlier detecting mechanism in which a possibility of being an outlier is higher as a difference between a local density of the noise-imparted training data and a local density of a point close thereto is larger, it means that the noise-imparted training data is deviated from the training data as the outlier score is larger. In this case, for example, the outlier detecting unit 53 sets, as the weight γ, a value normalized so that a value obtained by reversing a positive and a negative of the outlier score falls within a range of [0,1].

In addition, for example, the outlier detecting unit 53 may set a threshold (hereinafter, referred to as an “outlier determining threshold”) and set the weight γ by comparing the outlier score with the outlier determining threshold. For example, the outlier detecting unit 53 may set the weight γ=1 to noise-imparted training data deviated from the training data in which the outlier score is equal to or more than the outlier determining threshold, and may set the weight γ=0 to noise-imparted training data close to the training data in which the outlier score is less than the outlier determining threshold.

Note that the above-described example is merely an example. When the noise-imparted training data is deviated from the training data, whether the outlier score is equal to or more than the outlier determining threshold or less than the outlier determining threshold depends on the outlier detecting mechanism. When the weight γ is set by comparing the outlier score with the outlier determining threshold, the outlier detecting unit 53 only needs to compare the outlier score with the outlier determining threshold so as to set the weight γ=1 for noise-imparted training data deviated from the training data and the weight γ=0 for noise-imparted training data close to the training data.

The outlier detecting unit 53 outputs the set weight γ to the model learning unit 54.

The model learning unit 54 of the learning unit 5 calculates a loss function using the weight γ of NCP Loss set by the outlier detecting unit 53 and trains the machine learning model.

More specifically, the model learning unit 54 calculates the loss function using the weight γ set by the outlier detecting unit 53, and trains the machine learning model on the basis of the training data acquired by the training data acquiring unit 51 and the noise-imparted training data created by the noise imparting unit 52. As a result, the model learning unit 54 creates the machine learning model.

The model learning unit 54 uses the following loss function L(θ) in learning of the machine learning model. Note that the term following Epprior in the calculation equation of the following loss function L(θ) is the second term in the loss function used in training of the machine learning model described above.

$$L ( θ ) = - {E}_{ptrain ( x , y )} [ ln {p}_{model ( y \vert x , θ )} ] + γ {E}_{pprior ( \hat{x} )} [ {D}_{KL} [ {p}_{prior} ( \hat{y} \vert \hat{x} ‖ {p}_{model} ( \hat{y} \vert \hat{x} , θ ) ] ]$$

At this time, p_{model(y|x,θ)} is a probability distribution of output y obtained when an explanatory variable x is input in a parameter θ.

In addition, −E_{ptrain(x,y)}[Inp_{model(y|x,θ)}] is a maximum likelihood inference amount for the training data, and

$${D}_{KL} [ p ( y \vert x ) ‖ {p}_{model} ( y \vert x , θ ) ]$$

is satisfied.

D_{KL} refers to KL-divergence, and is not limited thereto as long as it is a method for obtaining an inter-distribution distance between a distribution p (y|x) of correct data and an output distribution p_{model}(y|x,θ) from the machine learning model. In the distribution p(y|x) of correct data, for example, a delta function may be regarded as a distribution, or the distribution p(y|x) of correct data may be a normal distribution.
The second term E_{pprior(\hat{x})}[D_{KL}[pₚᵣᵢₒᵣ(ŷ|\hat{x})∥p_{model}(ŷ|\hat{x},θ)]] of the loss function is a maximum likelihood inference amount for an explanatory variable \hat{x} and an objective variable ŷ after noise impartment, and an inter-distribution distance between a distribution (μ_{y}, σ_{y}) of the objective variable 9 after noise impartment and an output distribution p_{model}(ŷ|\hat{x},θ) from the machine learning model is calculated by KL-divergence.

Due to the weight γ of NCP Loss calculated from the outlier score by the outlier detecting unit 53, an influence of the second term is large in noise-imparted training data deviated from the training data, and the influence of the second term is small in noise-imparted training data close to the training data.

After training the machine learning model and creating the machine learning model, the model learning unit 54 of the learning unit 5 causes the model storing unit 55 to store the created machine learning model.

The model storing unit 55 stores the machine learning model.

Note that, here, the model storing unit 55 is included in the uncertainty learning device 2, but this is merely an example. The model storing unit 55 may be disposed at a place that can be referred to by the uncertainty learning device 2 outside the uncertainty learning device 2.

The inference unit 6 performs evaluation of the machine learning model created by the learning unit 5 and inference, in other words, prediction, of a predicted value and uncertainty using the machine learning model based on actual data, here, the operation-related data acquired from the machine device 1.

In the inference unit 6, the evaluation of the machine learning model created by the learning unit 5 is performed at the time of creating the machine learning model, that is, at the time of training. Note that the evaluation of the machine learning model is performed by the evaluation unit 64 of the inference unit 6.

In the inference unit 6, the inference of a predicted value and uncertainty using the machine learning model based on actual data is performed at the time of inference. Note that the inference using the machine learning model is performed by the prediction unit 62 of the inference unit 6.

The model reading unit 61 refers to the model storing unit 55 and reads the machine learning model.

The model reading unit 61 outputs the read machine learning model to the prediction unit 62 and the evaluation unit 64.

The test data acquiring unit 63 acquires test data from the test data storing unit 43.

The test data acquiring unit 63 outputs the acquired test data to the evaluation unit 64.

The evaluation unit 64 evaluate the machine learning model read by the model reading unit 61, in other words, the machine learning model created by the model learning unit 54 and stored by the model storing unit 55 using the test data acquired by the test data acquiring unit 63.

More specifically, the evaluation unit 64 evaluates accuracy of the machine learning model from the inference result (predicted value and uncertainty) output from the machine learning model and the objective variable of the test data acquired by the test data acquiring unit 63. The evaluation unit 64 only needs to use, as an evaluation index, a root mean square error (RMSE), a mean absolute error (MAE), a likelihood function, or the like. The evaluation unit 64 only needs to acquire the inference result output from the machine learning model from the model learning unit 54. Note that, in FIG. 3, an arrow from the model learning unit 54 to the evaluation unit 64 is not illustrated.

The evaluation unit 64 only needs to evaluate the machine learning model by a known machine learning model evaluating method using the test data.

The model learning unit 54 creates the machine learning model by inputting an explanatory variable to the machine learning model on the basis of the training data and performing training so that the output inference result (predicted value and uncertainty) matches an objective variable corresponding to the explanatory variable at the time of training. The evaluation unit 64 evaluates accuracy of the machine learning model in order to check how much the accuracy of the machine learning model created by the model learning unit 54 has been improved at the time of training.

By acquiring model input data based on the operation-related data from the machine device 1 and inputting the model input data to the machine learning model, the prediction unit 62 obtains a predicted value and uncertainty, thereby inferring the predicted value and the uncertainty.

As described above, the machine learning model receives, as an input, input data (here, model input data based on the operation-related data), and outputs a predicted value and uncertainty.

Note that the model input data input to the machine learning model by the prediction unit 62 is unknown data. The prediction unit 62 inputs the model input data, which is unknown data, to the machine learning model, and obtains a predicted value corresponding to an objective variable (position error, control value, or the like) of the unknown data and uncertainty for the predicted value. Here, the predicted value is, for example, a numerical value in a case of a regression problem, and is a probability of each class in a case of a classification problem. The uncertainty is, for example, a variance or a standard deviation indicating a variation in data.

Note that, as described above, the prediction unit 62 acquires the model input data to be an input of the machine learning model from the machine device 1 via the operation result acquiring unit 31 of the acquisition unit 3 and the preprocessing executing unit 41 of the preprocessing unit 4.

The prediction unit 62 outputs the obtained predicted value and uncertainty to the machine device 1.

When acquiring the predicted value and the uncertainty from the uncertainty learning device 2, the machine device 1 performs control on the basis of the acquired predicted value and uncertainty.

Here, the control based on the predicted value and the uncertainty in the machine device 1 will be described with a specific example. Here, as an example, it is assumed that a correction amount of a control command of a processing position based on data such as a CAD model and uncertainty thereof when a workpiece is processed (excavated) into some shape in the machine device 1 are output from the uncertainty learning device 2 as the predicted value and the uncertainty.

The machine device 1 corrects the control command on the basis of the correction amount and uncertainty thereof output from the uncertainty learning device 2. For example, when uncertainty a output from the uncertainty learning device 2 is equal to or more than a preset threshold (hereinafter, referred to as an “uncertainty determining threshold”) th, in short, when reliability of the predicted value is low, the machine device 1 determines the control command by the following equation. Note that, in the following equation, a control command U, an original command value u, and a correction amount f are used.

$$U = \{ \begin{matrix}u + f & if σ \leq th \\ u & if σ > th\end{matrix}$$

Note that the above-described example is merely an example, and, for example, the machine device 1 may perform no correction of the control command if the uncertainty is equal to or more than the uncertainty determining threshold, and may correct the control command if the uncertainty is less than the uncertainty determining threshold.

In addition, for example, in the uncertainty learning device 2, the prediction unit 62 may determine whether or not to output the obtained predicted value and uncertainty to the machine device 1. For example, the prediction unit 62 may output the predicted value and the uncertainty to the machine device 1 when the obtained uncertainty is less than the uncertainty determining threshold, and may perform no output of the predicted value and the uncertainty to the machine device 1 when the obtained uncertainty is equal to or more than the uncertainty determining threshold.

In addition, when the obtained uncertainty is high, the prediction unit 62 can also collect, as training data, the model input data from which the uncertainty has been obtained, in other words, the model input data input to the machine learning model, by an Active Learning method.

Operation of the uncertainty learning device 2 according to the first embodiment will be described.

Hereinafter, the operation of the uncertainty learning device 2 will be described separately for learning-time operation and inference-time operation.

First, the learning-time operation of the uncertainty learning device 2 will be described.

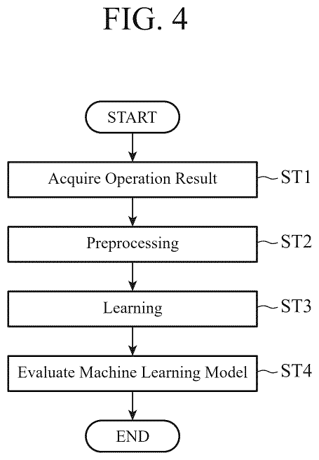

FIG. 4 is a flowchart for describing the learning-time operation of the uncertainty learning device 2 according to the first embodiment.

The uncertainty learning device 2 executes the learning-time operation as illustrated in the flowchart of FIG. 4, for example, on the basis of an instruction from a user. For example, the user operates an input device (not illustrated) and inputs an operation start instruction. When receiving the operation start instruction, a control unit (not illustrated) of the uncertainty learning device 2 causes the operation result acquiring unit 31, the preprocessing executing unit 41, the training data acquiring unit 51, the noise imparting unit 52, the outlier detecting unit 53, the model learning unit 54, the model reading unit 61, the test data acquiring unit 63, and the evaluation unit 64 to start operation. For example, the user may input the operation start instruction by inputting operation-related data. The uncertainty learning device 2 repeats the learning-time operation as illustrated in the flowchart of FIG. 4, for example, until the machine learning model is evaluated to some extent or until the control unit receives an operation end instruction from the user.

The operation result acquiring unit 31 acquires operation-related data from the machine device 1 (step ST1).

The operation result acquiring unit 31 causes the operation result storing unit 32 to store the acquired operation-related data.

The preprocessing executing unit 41 acquires the operation-related data acquired by the operation result acquiring unit 31 from the operation result storing unit 32 in step ST1, and performs preprocessing of shaping training data used by the learning unit 5 and test data used by the evaluation unit 64 of the inference unit 6, that is, learning-time preprocessing, on the basis of the operation-related data (step ST2).

The preprocessing executing unit 41 causes the training data storing unit 42 to store the training data created by performing the learning-time preprocessing. In addition, the preprocessing executing unit 41 causes the test data storing unit 43 to store the test data created by performing the learning-time preprocessing.

The learning unit 5 performs learning to create a machine learning model on the basis of the training data stored in the training data storing unit 42 and noise-imparted training data created on the basis of the training data (step ST3).

The learning unit 5 causes the model storing unit 55 to store the created machine learning model.

The evaluation unit 64 of the inference unit 6 evaluates the machine learning model created by the learning unit 5 in step ST3 (step ST4).

Specifically, the test data acquiring unit 63 acquires test data from the test data storing unit 43. Then, the evaluation unit 64 evaluates the machine learning model read by the model reading unit 61 using the test data acquired by the test data acquiring unit 63.

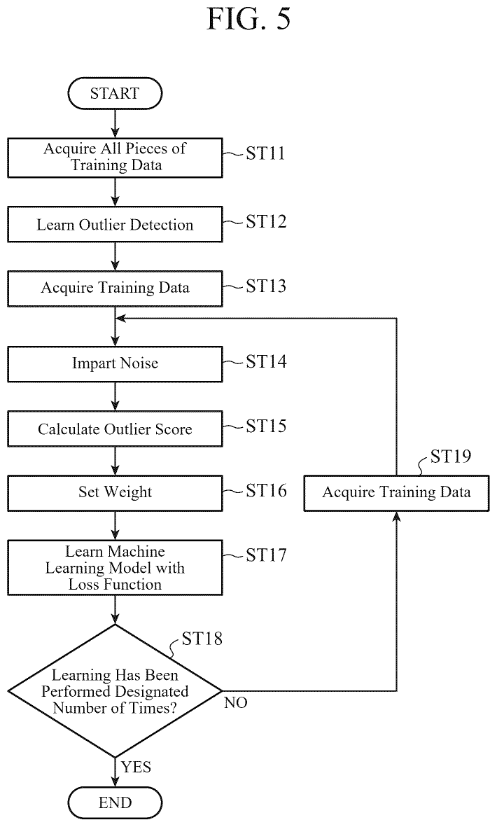

FIG. 5 is a flowchart for describing details of processing of step ST3 in FIG. 4.

The training data acquiring unit 51 acquires training data from the training data storing unit 42 (step ST11).

More specifically, the training data acquiring unit 51 acquires all pieces of training data from the training data storing unit 42.

The training data acquiring unit 51 outputs the acquired training data to the noise imparting unit 52, the outlier detecting unit 53, and the model learning unit 54.

In step ST11, the outlier detecting unit 53 inputs all pieces of the training data acquired by the training data acquiring unit 51 to the outlier detecting mechanism and learns all pieces of the training data (step ST12).

The noise imparting unit 52 acquires the training data acquired by the training data acquiring unit 51 in step ST11 (step ST13).

Here, the training data acquired by the noise imparting unit 52 may be all pieces of the training data acquired by the training data acquiring unit 51 or may be some pieces (mini-batch) of the training data acquired by the training data acquiring unit 51.

The noise imparting unit 52 imparts noise to the training data acquired in step ST13 and creates noise-imparted training data (step ST14).

The noise imparting unit 52 outputs the created noise-imparted training data to the outlier detecting unit 53 and the model learning unit 54.

The outlier detecting unit 53 calculates an outlier score from the training data acquired in step ST13 and the noise-imparted training data created by the noise imparting unit 52 in step ST14 (step ST15). More specifically, the outlier detecting unit 53 inputs the noise-imparted training data created by the noise imparting unit 52 to the outlier detecting mechanism learned in step ST12, and calculates an outlier score.

Then, the outlier detecting unit 53 sets a weight γ of NCP Loss from the calculated outlier score (step ST16).

The outlier detecting unit 53 outputs the set weight γ to the model learning unit 54.

The model learning unit 54 calculates a loss function using the weight γ of NCP Loss set by the outlier detecting unit 53 in step ST16, and trains the machine learning model on the basis of the training data acquired in step ST13 and the noise-imparted training data created in step ST14 (step ST17).

The model learning unit 54 determines whether training has been performed the designated number of times (step ST18).

Note that how many times the model learning unit 54 performs training is determined in advance by a user or the like.

If the model learning unit 54 has not performed training the designated number of times (“NO” in step ST18), the operation of the learning unit 5 proceeds to processing of step ST19, and the noise imparting unit 52 acquires the training data acquired by the training data acquiring unit 51 (step ST19).

Here, the training data acquired by the noise imparting unit 52 may be all pieces of the training data acquired by the training data acquiring unit 51 or may be some pieces (mini-batch) of the training data acquired by the training data acquiring unit 51.

Thereafter, the operation of the learning unit 5 proceeds to processing of step ST14. Note that, in this case, in step ST17, the model learning unit 54 calculates a loss function using the weight γ of NCP Loss set by the outlier detecting unit 53 in step ST16, and trains the machine learning model on the basis of the training data acquired in step ST19 and the noise-imparted training data created in step ST14.

On the other hand, if the model learning unit 54 has performed training the designated number of times (“YES” in step ST18), the model learning unit 54 causes the model storing unit 55 to store the machine learning model, and the operation of the learning unit 5 ends the processing as illustrated in the flowchart of FIG. 5.

Next, the inference-time operation of the uncertainty learning device 2 will be described.

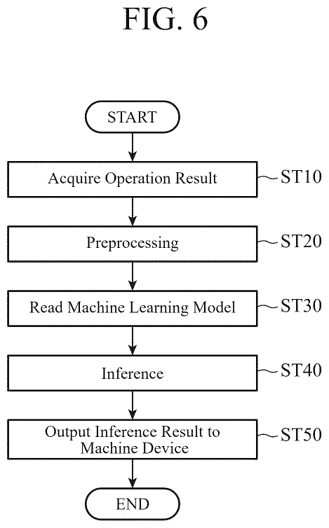

FIG. 6 is a flowchart for describing the inference-time operation of the uncertainty learning device 2 according to the first embodiment.

The uncertainty learning device 2 executes the inference-time operation as illustrated in the flowchart of FIG. 6, for example, on the basis of an instruction from a user. For example, the user operates an input device and inputs an operation start instruction. When receiving the operation start instruction, the control unit of the uncertainty learning device 2 causes the operation result acquiring unit 31, the preprocessing executing unit 41, the model reading unit 61, and the prediction unit 62 to start operation. The uncertainty learning device 2 repeats the inference-time operation as illustrated in the flowchart of FIG. 6, for example, until the control unit receives an operation end instruction from the user.

Note that the inference-time operation of the uncertainty learning device 2 described using the flowchart of FIG. 6 is based on an assumption that the learning-time operation of the uncertainty learning device 2 described using the flowchart of FIG. 4 is executed before the inference-time operation is executed.

The operation result acquiring unit 31 acquires operation-related data from the machine device 1 (step ST10).

The operation result acquiring unit 31 causes the operation result storing unit 32 to store the acquired operation-related data.

The preprocessing executing unit 41 acquires the operation-related data acquired by the operation result acquiring unit 31 in step ST10 from the operation result storing unit 32, and performs preprocessing of shaping model input data used by the prediction unit 62 of the inference unit 6 on the basis of the operation-related data, that is, inference-time preprocessing (step ST20).

The preprocessing executing unit 41 outputs the model input data created by performing the inference-time preprocessing to the prediction unit 62.

The model reading unit 61 refers to the model storing unit 55 and reads the machine learning model (step ST30).

The model reading unit 61 outputs the read machine learning model to the prediction unit 62.

By acquiring the model input data based on the operation-related data from the machine device 1 via the operation result acquiring unit 31 and the preprocessing executing unit 41 and inputting the model input data to the machine learning model, the prediction unit 62 obtains a predicted value and uncertainty, thereby inferring the predicted value and the uncertainty (step ST40).

Then, the prediction unit 62 outputs the obtained predicted value and uncertainty to the machine device 1 (step ST50).

In step ST50, the prediction unit 62 may determine whether or not to output the obtained predicted value and uncertainty to the machine device 1, and may output the obtained predicted value and uncertainty to the machine device 1 when determining to output the predicted value and the uncertainty to the machine device 1.

Note that, in the operation illustrated in the flowchart of FIG. 6, processing is performed in the order of step ST10, step ST20, and step ST30, but this is merely an example. For example, the processing of step ST30 may be performed before the processing of step ST10, or may be performed in parallel with the processing of steps ST10 and ST20.

As described above, the uncertainty learning device 2 imparts noise to the training data created on the basis of the operation result obtained from the machine device 1, and calculates an outlier score from the training data and the noise-imparted training data after the noise is imparted. Then, the uncertainty learning device 2 calculates a weighted loss function based on the calculated outlier score, and trains the machine learning model on the basis of the training data and the noise-imparted training data.

When calculating the loss function and training the machine learning model, the uncertainty learning device 2 trains the machine learning model so that the uncertainty is high for extrapolation data far from the training data and the uncertainty is low for data close to the training data due to the weight γ set on the basis of the outlier score. As a result, the uncertainty learning device 2 can provide a machine learning model capable of inferring uncertainty more accurately.

In the conventional technique as described above, training is performed so that uncertainty is high for extrapolation data far from the training data by learning the second term of the loss function with the noise-imparted data, but there is a portion where the uncertainty may be high also for data close to the training data or the training data itself. On the other hand, the uncertainty learning device 2 can provide a machine learning model in which inference accuracy of uncertainty is further improved.

That is, the uncertainty learning device 2 can provide a machine learning model capable of more accurately inferring uncertainty for both the extrapolation data and data close to the training data by controlling data used for the training data by the outlier detecting technique instead of training all pieces of data to which noise is imparted in a single machine learning model capable of inferring both a predicted value and uncertainty.

Note that, as a technique for inferring a predicted value and uncertainty, for example, as disclosed in the following Reference Literature, a technique is known in which a predicted value and uncertainty are acquired by iteratively applying Monte Carlo dropout to one neural network, and calibration is performed with a fitness function that evaluates accuracy of the predicted value and the uncertainty.
(Reference Literature) JP 2018-200677 A

However, when the Monte Carlo dropout is iteratively applied as in the above-described technique, a calculation time for prediction is long, and therefore, application to one having a control period in units of milliseconds, such as an FA device, is difficult.

The uncertainty learning device 2 according to the first embodiment can provide a machine learning model capable of outputting a predicted value and uncertainty applicable to control of the machine device 1 having a control period in units of milliseconds, such as an FA device.

In the first embodiment described above, the uncertainty learning device 2 includes the acquisition unit 3, the preprocessing unit 4, and the inference unit 6, but this is merely an example.

The uncertainty learning device 2 only needs to include at least the learning unit 5, and for example, the acquisition unit 3, the preprocessing unit 4, and the inference unit 6 may be arranged at a place that can be referred to by the uncertainty learning device 2 outside the uncertainty learning device 2.

When the uncertainty learning device 2 does not include the acquisition unit 3, the preprocessing unit 4, and the inference unit 6, the processing of steps ST1, ST2, and ST4 can be omitted in the operation of the uncertainty learning device 2 described with reference to the flowchart of FIG. 4. In addition, the uncertainty learning device 2 can omit the operation described with reference to the flowchart of FIG. 6.

In addition, in the first embodiment described above, the uncertainty learning device 2 is included in the server, but this is merely an example.

For example, the uncertainty learning device 2 may be included in the machine device 1.

In addition, for example, in the uncertainty learning device 2, some or all of the operation result acquiring unit 31, the preprocessing executing unit 41, the training data acquiring unit 51, the noise imparting unit 52, the outlier detecting unit 53, the model learning unit 54, the model reading unit 61, the prediction unit 62, the test data acquiring unit 63, and the evaluation unit 64 may be included in a device or the like outside the server.

In addition, in the first embodiment described above, the machine device 1 is an FA device, but this is merely an example. For example, the machine device 1 can be any one of various devices that solve various tasks using a machine learning model, such as a control device that performs automatic driving control of a mobile object and a medical device used at a medical site.

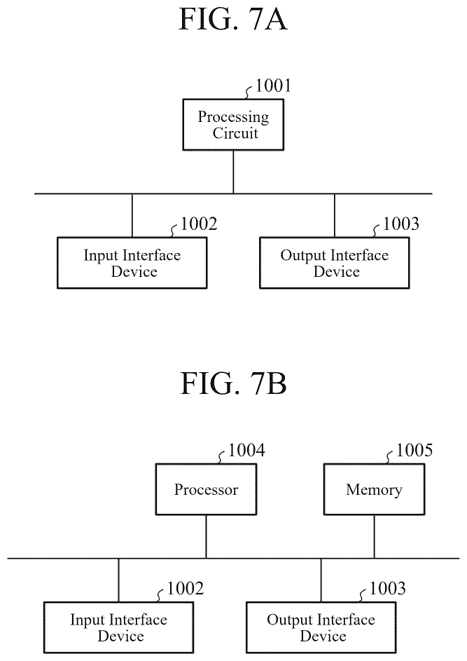

FIGS. 7A and 7B are each a diagram illustrating an example of a hardware configuration of the uncertainty learning device 2 according to the first embodiment.

In the first embodiment, functions of the operation result acquiring unit 31, the preprocessing executing unit 41, the training data acquiring unit 51, the noise imparting unit 52, the outlier detecting unit 53, the model learning unit 54, the model reading unit 61, the prediction unit 62, the test data acquiring unit 63, the evaluation unit 64, and the control unit (not illustrated) are implemented by a processing circuit 1001. That is, the uncertainty learning device 2 includes the processing circuit 1001 for performing control to create a machine learning model capable of inferring uncertainty more accurately by performing training so that uncertainty is high for extrapolation data and the uncertainty is low for data close to the training data due to the weight γ set on the basis of an outlier score.

The processing circuit 1001 may be dedicated hardware as illustrated in FIG. 7A, or a processor 1004 that executes a program stored in a memory as illustrated in FIG. 7B.

When the processing circuit 1001 is dedicated hardware, for example, a single circuit, a composite circuit, a programmed processor, a parallel programmed processor, an application specific integrated circuit (ASIC), a field-programmable gate array (FPGA), or a combination thereof corresponds to the processing circuit 1001.

When the processing circuit is the processor 1004, the functions of the operation result acquiring unit 31, the preprocessing executing unit 41, the training data acquiring unit 51, the noise imparting unit 52, the outlier detecting unit 53, the model learning unit 54, the model reading unit 61, the prediction unit 62, the test data acquiring unit 63, the evaluation unit 64, and the control unit (not illustrated) are implemented by software, firmware, or a combination of software and firmware. Software or firmware is described as a program and stored in a memory 1005. By reading and executing the program stored in the memory 1005, the processor 1004 executes the functions of the operation result acquiring unit 31, the preprocessing executing unit 41, the training data acquiring unit 51, the noise imparting unit 52, the outlier detecting unit 53, the model learning unit 54, the model reading unit 61, the prediction unit 62, the test data acquiring unit 63, the evaluation unit 64, and the control unit (not illustrated). That is, the uncertainty learning device 2 includes the memory 1005 for storing a program that causes the above-described steps ST1 to ST4 illustrated in FIG. 4 or the above-described steps ST10 to ST50 illustrated in FIG. 6 to be executed as a result when the program is executed by the processor 1004. In addition, it can also be said that the program stored in the memory 1005 causes a computer to execute a processing procedure or method performed by the operation result acquiring unit 31, the preprocessing executing unit 41, the training data acquiring unit 51, the noise imparting unit 52, the outlier detecting unit 53, the model learning unit 54, the model reading unit 61, the prediction unit 62, the test data acquiring unit 63, the evaluation unit 64, and the control unit (not illustrated). Here, to the memory 1005, for example, a nonvolatile or volatile semiconductor memory such as a RAM, a read only memory (ROM), a flash memory, an erasable programmable read only memory (EPROM), or an electrically erasable programmable read-only memory (EEPROM) (registered trademark, which will not be described hereinafter), a magnetic disk, a flexible disk, an optical disc, a compact disc, a mini disc, or a digital versatile disk (DVD) corresponds.

Note that the functions of the operation result acquiring unit 31, the preprocessing executing unit 41, the training data acquiring unit 51, the noise imparting unit 52, the outlier detecting unit 53, the model learning unit 54, the model reading unit 61, the prediction unit 62, the test data acquiring unit 63, the evaluation unit 64, and the control unit (not illustrated) may be partially implemented by dedicated hardware and partially implemented by software or firmware. For example, the functions of the operation result acquiring unit 31 and the preprocessing executing unit 41 can be implemented by the processing circuit 1001 as dedicated hardware, and the functions of the training data acquiring unit 51, the noise imparting unit 52, the outlier detecting unit 53, the model learning unit 54, the model reading unit 61, the prediction unit 62, the test data acquiring unit 63, the evaluation unit 64, and the control unit (not illustrated) can be implemented by the processor 1004 reading and executing a program stored in the memory 1005.

Each of the operation result storing unit 32, the training data storing unit 42, the test data storing unit 43, and the model storing unit 55 is constituted by, for example, a hard disk drive (HDD, not illustrated) or a solid state drive (SSD, not illustrated).

In addition, the uncertainty learning device 2 includes an input interface device 1002 and an output interface device 1003 that perform wired communication or wireless communication with a device such as the machine device 1.

As described above, the uncertainty learning device 2 according to the first embodiment includes: the training data acquiring unit 51 that acquires training data created on the basis of operation-related data obtained from the machine device 1; the noise imparting unit 52 that creates noise-imparted training data in which noise is imparted to the training data acquired by the training data acquiring unit 51; the outlier detecting unit 53 that calculates an outlier score from the training data acquired by the training data acquiring unit 51 and the noise-imparted training data created by the noise imparting unit 52; and the model learning unit 54 that calculates a weighted loss function based on the outlier score calculated by the outlier detecting unit 53, and trains a machine learning model on the basis of the training data and the noise-imparted training data.

Therefore, the uncertainty learning device 2 can provide a machine learning model capable of inferring uncertainty more accurately as compared with a machine learning model created by a conventional method for training a machine learning model by imparting noise to all pieces of training data.

### Second Embodiment

Even when a plurality of pieces of operation-related data obtained from a machine device has the same value, conditions when the plurality of pieces of operation-related data is obtained may be different. For example, when sheet metals made of two different materials A and B are processed by a machine tool, the machine tool sends the sheet metals at the same speed, but behavior thereof may be different due to the difference in material. For example, when a machine learning model trained on the basis of operation-related data obtained when the material A is processed is used to infer a predicted value and uncertainty from operation-related data obtained when the material B is processed, the inferred uncertainty is low. This is because each of the operation-related data obtained when the material A is processed and the operation-related data obtained when the material B is processed is operation-related data obtained by processing the material A or the material B at the same speed, and therefore a machine learning model erroneously recognizes that these are the same data, that is, erroneously recognizes that these are learned data, and infers low uncertainty.

In the first embodiment, the above has not been considered.

A second embodiment will describe an embodiment of creating a machine learning model capable of inferring high uncertainty by using data acquired by an external sensor, which cannot be acquired by a machine device, even when certain explanatory variables have the same value, because pieces of the data acquired by the external sensor are different.

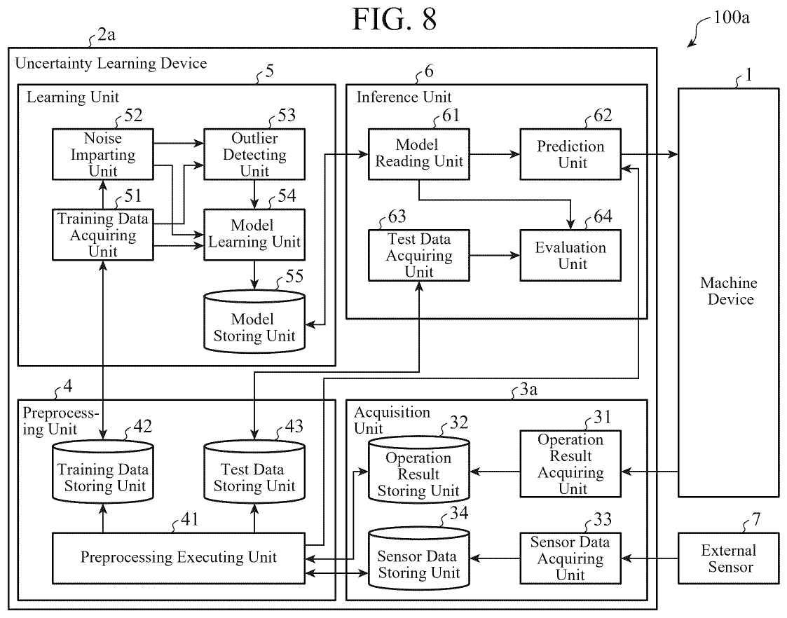

FIG. 8 is a diagram illustrating a configuration example of an uncertainty learning system 100a including an uncertainty learning device 2a according to the second embodiment.

The uncertainty learning system 100a includes the uncertainty learning device 2a, a machine device 1, and an external sensor 7. The uncertainty learning device 2a is connected to the machine device 1 and the external sensor 7 via a network.

In the second embodiment, the machine device 1 is assumed to be, for example, an FA device.

The external sensor 7 is any one of various sensors such as a temperature sensor, a humidity sensor, and a vibration sensor disposed outside the machine device 1 independently of the machine device 1.

The uncertainty learning device 2a according to the second embodiment is included in, for example, a server.

In a configuration example of the uncertainty learning device 2a according to the second embodiment, similar components to those of the configuration example of the uncertainty learning device 2 according to the first embodiment described with reference to FIG. 3 are denoted by the same reference numerals, and redundant description is omitted.

The configuration example of the uncertainty learning device 2a is different from the configuration example of the uncertainty learning device 2 according to the first embodiment in that an acquisition unit 3a includes a sensor data acquiring unit 33 and a sensor data storing unit 34 in addition to an operation result acquiring unit 31 and an operation result storing unit 32.

The sensor data acquiring unit 33 functions at the time of training and at the time of inference.

Note that, in the second embodiment, similarly to the uncertainty learning device 2 according to the first embodiment, the uncertainty learning device 2a performs “learning” of creating a machine learning model and “inference” of inferring a predicted value and uncertainty using the machine learning model created by “learning”.

The sensor data acquiring unit 33 acquires data (hereinafter, referred to as “sensor data”) acquired by the external sensor 7 from the external sensor 7.

The sensor data acquired by the sensor data acquiring unit 33 from the external sensor 7 includes, for example, at least one of temperature data of a place where the machine device 1 is disposed, humidity data of the place where the machine device 1 is disposed, vibration data of the machine device 1, data related to a state of the machine device 1, and data related to a task of the machine device 1. For example, in a case of a processing machine, examples of the sensor data include data indicating a temperature of the machine device 1, vibration of the machine device 1, and the shape of a workpiece, which affect smoothness of a processing shape or a processing speed.

The sensor data acquiring unit 33 causes the sensor data storing unit 34 to store the acquired sensor data. For example, the sensor data acquiring unit 33 imparts an acquisition date and time of the sensor data to the sensor data and causes the sensor data storing unit 34 to store the sensor data.

The sensor data storing unit 34 stores the sensor data acquired by the sensor data acquiring unit 33.

Note that, here, the sensor data storing unit 34 is included in the uncertainty learning device 2a, but this is merely an example. The sensor data storing unit 34 may be disposed at a place that can be referred to by the uncertainty learning device 2a outside the uncertainty learning device 2a.

In the second embodiment, a preprocessing executing unit 41 of a preprocessing unit 4 acquires operation-related data acquired by the operation result acquiring unit 31 from the operation result storing unit 32, and acquires the sensor data acquired by the sensor data acquiring unit 33 from the sensor data storing unit 34.

Then, the preprocessing executing unit 41 performs learning-time preprocessing of shaping training data used by a learning unit 5 and test data used by an evaluation unit 64 of an inference unit 6 on the basis of the operation-related data and the sensor data.

More specifically, the preprocessing executing unit 41 adds the sensor data obtained by the external sensor 7 to an explanatory variable.

In addition, the preprocessing executing unit 41 acquires the operation-related data acquired by the operation result acquiring unit 31 from the operation result storing unit 32, acquires the sensor data acquired by the sensor data acquiring unit 33 from the sensor data storing unit 34, and performs preprocessing of shaping model input data used by a prediction unit 62 of the inference unit 6 on the basis of the operation-related data and the sensor data, that is, inference-time preprocessing.

The learning unit 5 creates a machine learning model on the basis of training data including the explanatory variable based on the sensor data.

Since a specific method for creating a machine learning model by the learning unit 5 is similar to the specific creating method described in the first embodiment, redundant description is omitted.

The learning unit 5 creates one machine learning model on the basis of the training data created by the preprocessing executing unit 41 on the basis of the operation-related data and the sensor data.

Note that this is merely an example, and for example, when some pieces of sensor data having different contents at the time of operation of the machine device 1 have been acquired by the sensor data acquiring unit 33, the learning unit 5 may create the machine learning model for each content of the sensor data.

In this case, for example, the preprocessing executing unit 41 creates training data and test data grouped on the basis of the contents of the sensor data in the learning-time preprocessing. The learning unit 5 creates the machine learning model on the basis of the training data for each group. Note that, when the machine learning model is created for each content of the sensor data, the preprocessing executing unit 41 only needs to use the sensor data for grouping the training data and the test data based on the operation-related data, and does not need to add the sensor data to the explanatory variable.

As a specific example, for example, it is assumed that data indicating various types (for example, a circle or a straight line) of processing shapes is acquired as the sensor data. In this case, the preprocessing executing unit 41 creates training data and test data based on the operation-related data for each type of processing shape, and associates sensor data indicating the type of processing shape with each of the created training data and test data.

The learning unit 5 creates the machine learning model for each type of processing shape. For example, in the machine device 1, when an operation pattern (operation mode) changes depending on the type of the processing shape, the uncertainty learning device 2a can provide a machine learning model corresponding to the operation pattern of the machine device 1 by creating the machine learning model for each type of the processing shape.

Note that, in the learning unit 5, a model learning unit 54 causes a model storing unit 55 to store the created machine learning model and the sensor data, in the above-described example, the data indicating the type of processing shape in association with each other.

In the inference unit 6, a model reading unit 61 reads a machine learning model corresponding to the test data grouped on the basis of the contents of the sensor data. For example, the model reading unit 61 only needs to acquire test data from a test data acquiring unit 63 and only needs to specify a machine learning model to be read from sensor data associated with the test data. Note that, in FIG. 8, an arrow from the test data acquiring unit 63 to the model reading unit 61 is not illustrated.

The evaluation unit 64 of the inference unit 6 evaluates the machine learning model corresponding to the sensor data associated with the test data using the test data acquired by the test data acquiring unit 63.

By inputting the model input data created by the preprocessing executing unit 41 in the inference-time preprocessing to the machine learning model corresponding to the sensor data associated with the model input data, the prediction unit 62 of the inference unit 6 obtains a predicted value and uncertainty, thereby inferring the predicted value and the uncertainty. Note that, when the machine learning model is created for each content of the sensor data, the preprocessing executing unit 41 creates model input data for each content of the sensor data in the inference-time preprocessing, and outputs the created model input data and the sensor data to the prediction unit 62 in association with each other.

Operation of the uncertainty learning device 2a according to the second embodiment will be described.

First, learning-time operation of the uncertainty learning device 2a according to the second embodiment will be described.

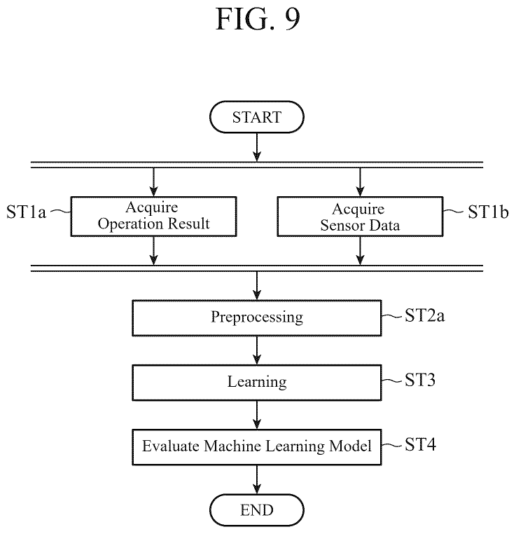

FIG. 9 is a flowchart for describing the learning-time operation of the uncertainty learning device 2a according to the second embodiment.

Note that the learning-time operation of the uncertainty learning device 2a illustrated in FIG. 9 is operation when the learning unit 5 creates one machine learning model in the uncertainty learning device 2a.

The uncertainty learning device 2a executes the learning-time operation as illustrated in the flowchart of FIG. 9, for example, on the basis of an instruction from a user. For example, the user operates an input device (not illustrated) and inputs an operation start instruction. When receiving the operation start instruction, a control unit (not illustrated) of the uncertainty learning device 2a causes the operation result acquiring unit 31, the sensor data acquiring unit 33, the preprocessing executing unit 41, the training data acquiring unit 51, the noise imparting unit 52, the outlier detecting unit 53, the model learning unit 54, the model reading unit 61, the test data acquiring unit 63, and the evaluation unit 64 to start operation. For example, the user may input the operation start instruction by inputting operation-related data. The uncertainty learning device 2a repeats the learning-time operation as illustrated in the flowchart of FIG. 9, for example, until the machine learning model is evaluated to some extent or until the control unit receives an operation end instruction from the user.

Since specific contents of the processing of steps ST3 and ST4 in FIG. 9 are similar to those of the processing of steps ST3 and ST4 in FIG. 4 described in the first embodiment, respectively, redundant description is omitted. Note that the processing of step ST3 in FIG. 9 in the uncertainty learning device 2a is specifically the processing as illustrated in the flowchart of FIG. 5. Since operation of the uncertainty learning device 2a illustrated in the flowchart of FIG. 5, more specifically, the model learning unit 54 has been described in the first embodiment, redundant description is omitted.

The operation result acquiring unit 31 acquires operation-related data from the machine device 1 (step ST1a).

The operation result acquiring unit 31 causes the operation result storing unit 32 to store the acquired operation-related data.

The sensor data acquiring unit 33 acquires sensor data from the external sensor 7 (step ST1b).

The sensor data acquiring unit 33 causes the sensor data storing unit 34 to store the acquired sensor data.

The preprocessing executing unit 41 acquires operation-related data acquired by the operation result acquiring unit 31 from the operation result storing unit 32 in step ST1a, and acquires the sensor data acquired by the sensor data acquiring unit 33 from the sensor data storing unit 34 in step ST1b.

The preprocessing executing unit 41 performs preprocessing of shaping training data used by the learning unit 5 and test data used by the inference unit 6 on the basis of the operation-related data and the sensor data, that is, learning-time preprocessing (step ST2a).

The preprocessing executing unit 41 causes the training data storing unit 42 to store the training data created by performing the learning-time preprocessing. In addition, the preprocessing executing unit 41 causes the test data storing unit 43 to store the test data created by performing the learning-time preprocessing.

Note that, for example, when the learning unit 5, more specifically, the model learning unit 54 of the learning unit 5 creates a machine learning model for each content of the sensor data, the preprocessing executing unit 41 creates training data and test data grouped on the basis of the type of sensor data in the learning-time preprocessing in step ST2a. In step ST3, the learning unit 5 creates a machine learning model for each content of the sensor data. In step ST4, the model reading unit 61 of the inference unit 6 reads a machine learning model corresponding to the sensor data, and the evaluation unit 64 evaluates the machine learning model corresponding to the sensor data associated with the test data using the test data acquired by the test data acquiring unit 63.

Next, inference-time operation of the uncertainty learning device 2a according to the second embodiment will be described.

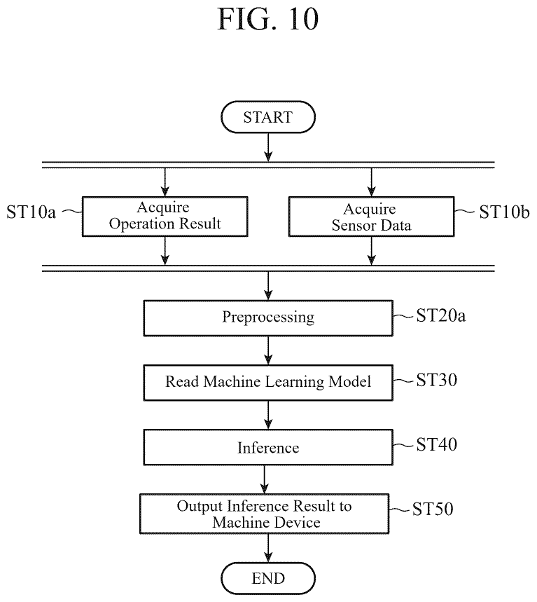

FIG. 10 is a flowchart for describing the inference-time operation of the uncertainty learning device 2a according to the second embodiment.

Note that the inference-time operation of the uncertainty learning device 2a illustrated in FIG. 10 is operation when the learning unit 5 creates one machine learning model in the uncertainty learning device 2a.

The uncertainty learning device 2a executes the learning-time operation as illustrated in the flowchart of FIG. 10, for example, on the basis of an instruction from a user. For example, the user operates an input device and inputs an operation start instruction. When receiving the operation start instruction, the control unit of the uncertainty learning device 2a causes the operation result acquiring unit 31, the sensor data acquiring unit 33, the preprocessing executing unit 41, the model reading unit 61, and the prediction unit 62 to start operation. The uncertainty learning device 2a repeats the inference-time operation as illustrated in the flowchart of FIG. 10, for example, until the control unit receives an operation end instruction from the user.

Note that the inference-time operation of the uncertainty learning device 2a described using the flowchart of FIG. 10 is based on an assumption that the learning-time operation of the uncertainty learning device 2a described using the flowchart of FIG. 9 is executed before the inference-time operation is executed.

Since specific contents of the processing of steps ST30 to ST50 in FIG. 10 are similar to those of the processing of steps ST30 to ST50 in FIG. 6 described in the first embodiment, respectively, redundant description is omitted.

The operation result acquiring unit 31 acquires operation-related data from the machine device 1 (step ST10a).

The operation result acquiring unit 31 causes the operation result storing unit 32 to store the acquired operation-related data.

The sensor data acquiring unit 33 acquires sensor data from the external sensor 7 (step ST10b).

The sensor data acquiring unit 33 causes the sensor data storing unit 34 to store the acquired sensor data.

The preprocessing executing unit 41 acquires the operation-related data acquired by the operation result acquiring unit 31 in step ST10a from the operation result storing unit 32, acquires the sensor data acquired by the sensor data acquiring unit 33 in step ST10b from the sensor data storing unit 34, and performs preprocessing of shaping model input data used by the prediction unit 62 of the inference unit 6 on the basis of the operation-related data and the sensor data, that is, inference-time preprocessing (step ST20a).

The preprocessing executing unit 41 outputs the model input data created by performing the inference-time preprocessing to the prediction unit 62.

Note that, in the operation illustrated in the flowchart of FIG. 10, processing is performed in the order of steps ST10a and 10b, step ST20a, and step ST30, but this is merely an example. For example, the processing of step ST30 may be performed before the processing of steps ST10a and 10b, or may be performed in parallel with the processing of steps ST10a and 10b and step ST20.

In addition, for example, when the learning unit 5, more specifically, the model learning unit 54 of the learning unit 5 creates the machine learning model for each content of the sensor data, the preprocessing executing unit 41 creates model input data for each content of the sensor data in step ST20a, and outputs the created model input data and the sensor data to the prediction unit 62 in association with each other. In step ST40, the model reading unit 61 of the inference unit 6 reads a machine learning model corresponding to the sensor data, and in step ST50, by inputting the model input data created by the preprocessing executing unit 41 to the machine learning model corresponding to the sensor data associated with the model input data, the prediction unit 62 obtains a predicted value and uncertainty, thereby inferring the predicted value and the uncertainty.

As described above, the uncertainty learning device 2a acquires the sensor data acquired by the external sensor 7 disposed independently of the machine device 1, and acquires training data created on the basis of the operation-related data obtained from the machine device 1 and the sensor data. As described above, the uncertainty learning device 2a imparts noise to the training data created on the basis of the operation-related data and the sensor data, and calculates an outlier score from the training data and the noise-imparted training data after the noise is imparted. Then, the uncertainty learning device 2a calculates a weighted loss function based on the calculated outlier score, and trains the machine learning model on the basis of the training data and the noise-imparted training data.

By creating a machine learning model capable of recognizing a difference in operation-related data caused by a difference in operation result, in other words, a difference in conditions when the operation-related data is obtained, the uncertainty learning device 2a can provide a machine learning model in which inference accuracy of uncertainty is further improved.

Note that, in the second embodiment described above, the uncertainty learning device 2a includes the acquisition unit 3a, the preprocessing unit 4, and the inference unit 6, but this is merely an example.

The uncertainty learning device 2a only needs to include at least the learning unit 5, and for example, the acquisition unit 3a, the preprocessing unit 4, and the inference unit 6 may be arranged at a place that can be referred to by the uncertainty learning device 2a outside the uncertainty learning device 2a.

When the uncertainty learning device 2a does not include the acquisition unit 3a, the preprocessing unit 4, and the inference unit 6, the processing of steps ST1a, ST1b, ST2a, and ST4 can be omitted in the operation of the uncertainty learning device 2a described with reference to the flowchart of FIG. 9. In addition, the uncertainty learning device 2a can omit the operation described with reference to the flowchart of FIG. 10.

In addition, in the second embodiment described above, the uncertainty learning device 2a is included in the server, but this is merely an example.

For example, the uncertainty learning device 2a may be included in the machine device 1.

In addition, for example, in the uncertainty learning device 2a, some or all of the operation result acquiring unit 31, the sensor data acquiring unit 33, the preprocessing executing unit 41, the training data acquiring unit 51, the noise imparting unit 52, the outlier detecting unit 53, the model learning unit 54, the model reading unit 61, the prediction unit 62, the test data acquiring unit 63, and the evaluation unit 64 may be included in a device or the like outside the server.

In addition, in the second embodiment described above, the machine device 1 is an FA device, but this is merely an example. For example, the machine device 1 can be any one of various devices that solve various tasks using a machine learning model, such as a control device that performs automatic driving control of a mobile object and a medical device used at a medical site.

Since a hardware configuration of the uncertainty learning device 2a according to the second embodiment is the configuration described with reference to FIGS. 7A and 7B in the first embodiment, description thereof is omitted.

In the second embodiment, functions of the operation result acquiring unit 31, the sensor data acquiring unit 33, the preprocessing executing unit 41, the training data acquiring unit 51, the noise imparting unit 52, the outlier detecting unit 53, the model learning unit 54, the model reading unit 61, the prediction unit 62, the test data acquiring unit 63, the evaluation unit 64, and the control unit (not illustrated) are implemented by the processing circuit 1001. That is, the uncertainty learning device 2a includes the processing circuit 1001 for performing control to create a machine learning model that is capable of inferring uncertainty more accurately by performing training so that uncertainty is high for extrapolation data and the uncertainty is low for data close to the training data due to the weight γ set on the basis of an outlier score, and capable of recognizing a difference in operation-related data caused by a difference in conditions when the operation-related data is obtained.

The processing circuit 1001 may be dedicated hardware as illustrated in FIG. 7A, or the processor 1004 that executes a program stored in the memory as illustrated in FIG. 7B.

By reading and executing the program stored in a memory 1005, the processing circuit 1001 executes the functions of the operation result acquiring unit 31, the sensor data acquiring unit 33, the preprocessing executing unit 41, the training data acquiring unit 51, the noise imparting unit 52, the outlier detecting unit 53, the model learning unit 54, the model reading unit 61, the prediction unit 62, the test data acquiring unit 63, the evaluation unit 64, and the control unit (not illustrated). That is, the uncertainty learning device 2a includes the memory 1005 for storing a program that causes the above-described steps ST1a and ST1b to ST4 illustrated in FIG. 9 or the above-described steps ST10a and ST10b to ST50 illustrated in FIG. 10 to be executed as a result when the program is executed by the processing circuit 1001. In addition, it can also be said that the program stored in the memory 1005 causes a computer to execute a processing procedure or method performed by the operation result acquiring unit 31, the sensor data acquiring unit 33, the preprocessing executing unit 41, the training data acquiring unit 51, the noise imparting unit 52, the outlier detecting unit 53, the model learning unit 54, the model reading unit 61, the prediction unit 62, the test data acquiring unit 63, the evaluation unit 64, and the control unit (not illustrated).

Each of the operation result storing unit 32, the sensor data storing unit 34, the training data storing unit 42, the test data storing unit 43, and the model storing unit 55 is constituted by, for example, an HDD or an SSD.

In addition, the uncertainty learning device 2a includes the input interface device 1002 and the output interface device 1003 that perform wired communication or wireless communication with a device such as the machine device 1.

As described above, the uncertainty learning device 2a according to the second embodiment includes the sensor data acquiring unit 33 that acquires sensor data acquired by the external sensor 7 disposed independently of the machine device 1, and the training data acquiring unit 51 acquires training data created on the basis of operation-related data acquired from the machine device 1 and the sensor data acquired by the sensor data acquiring unit 33.

In the uncertainty learning device 2a, the model learning unit 54 calculates a weighted loss function based on an outlier score calculated by the outlier detecting unit 53, and trains a machine learning model on the basis of the training data created on the basis of the operation-related data and the sensor data and noise-imparted training data.

Therefore, the uncertainty learning device 2a can provide a machine learning model capable of inferring uncertainty more accurately as compared with a machine learning model created by a conventional method for training a machine learning model by imparting noise to all pieces of training data. In addition, by creating a machine learning model capable of recognizing a difference in operation-related data caused by a difference in operation result, in other words, a difference in conditions when the operation-related data is obtained, the uncertainty learning device 2a can provide a machine learning model in which inference accuracy of uncertainty is further improved.

### Third Embodiment

Even when the machine device 1 is not operated, data (hereinafter, referred to as “simulation data”) obtained by causing a simulator to perform simulation operation in advance or operation-related data at the time of operation of the machine device 1 in the past may be acquired.

In a third embodiment, an embodiment will be described in which a machine learning model is created using simulation data acquired in advance or past operation-related data, and on the basis of the machine learning model, a machine learning model is created by performing transfer learning on training data created from operation-related data obtained by operating a machine device 1.

In the following third embodiment, simulation data acquired in advance or past operation-related data is referred to as “prior data”, and a machine learning model created using the prior data is referred to as “prior learning model”.

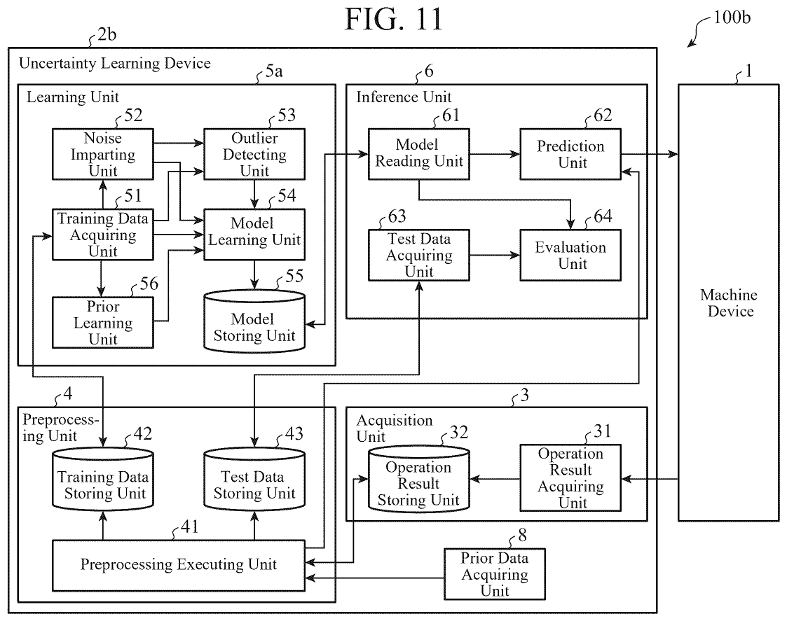

FIG. 11 is a diagram illustrating a configuration example of an uncertainty learning system 100b including an uncertainty learning device 2b according to the third embodiment.

The uncertainty learning system 100b includes the uncertainty learning device 2b and the machine device 1. The uncertainty learning device 2b is connected to the machine device 1 via a network.

In the third embodiment, the machine device 1 is assumed to be, for example, an FA device.

The uncertainty learning device 2b according to the third embodiment is included in, for example, a server.

In a configuration example of the uncertainty learning device 2b according to the third embodiment, similar components to those of the configuration example of the uncertainty learning device 2 according to the first embodiment described with reference to FIG. 3 are denoted by the same reference numerals, and redundant description is omitted.

The configuration example of the uncertainty learning device 2b is different from the configuration example of the uncertainty learning device 2 according to the first embodiment in that the configuration example of the uncertainty learning device 2b includes a prior data acquiring unit 8 and that a learning unit 5a includes a prior learning unit 56 in addition to a training data acquiring unit 51, a noise imparting unit 52, an outlier detecting unit 53, a model learning unit 54, and a model storing unit 55.

The prior data acquiring unit 8 and the prior learning unit 56 function at the time of training.

Note that, in the third embodiment, similarly to the uncertainty learning device 2 according to the first embodiment, the uncertainty learning device 2b performs “learning” of creating a machine learning model and “inference” of inferring a predicted value and uncertainty using the machine learning model created by “learning”.

The prior data acquiring unit 8 acquires prior data.

For example, simulation data obtained by causing a simulator (not illustrated) to execute simulation operation or operation-related data acquired when the machine device 1 operated in the past is stored in a cloud (not illustrated) as the prior data. The prior data acquiring unit 8 checks whether or not the prior data is stored in the cloud, and acquires the prior data when the prior data is stored.

Note that the simulator simulatively reproduces operation or behavior of the machine device 1. Simulation data obtained by causing the simulator to execute simulation operation includes, for example, data indicating a value unique to the machine device 1, such as a parameter set in the machine device 1, a configuration of the machine device 1, or an operation mode thereof, and log data operated by the machine device 1.

The prior data acquiring unit 8 outputs the acquired prior data to a preprocessing executing unit 41 of a preprocessing unit 4.

In the third embodiment, when prior data is output from the prior data acquiring unit 8, the preprocessing executing unit 41 acquires the prior data, and performs learning-time preprocessing of shaping training data used by the prior learning unit 56 of the learning unit 5a on the basis of the prior data. Details of the prior learning unit 56 will be described later.

In addition, the preprocessing executing unit 41 acquires operation-related data acquired by an operation result acquiring unit 31 from an operation result storing unit 32, and performs learning-time preprocessing of shaping training data used by the model learning unit 54 of the learning unit 5a and test data used by an evaluation unit 64 of an inference unit 6 on the basis of the operation-related data.

Details of the learning-time preprocessing based on the operation-related data, which is performed by the preprocessing executing unit 41, have already been described in the first embodiment, and thus redundant description is omitted. In addition, the preprocessing executing unit 41 only needs to shape the training data based on the prior data by a method similar to the method for shaping the training data on the basis of the operation-related data.

The preprocessing executing unit 41 adds, to the training data created by performing the learning-time preprocessing based on the prior data, data indicating that the training data is training data based on the prior data, and causes a training data storing unit 42 to store the training data. In the following third embodiment, the training data based on the prior data is also referred to as “prior training data”. When creating the training data by performing the learning-time preprocessing based on the operation-related data, the preprocessing executing unit 41 adds, to the created training data, data indicating that the training data is training data based on the operation-related data, and causes the training data storing unit 42 to store the training data. In addition, the preprocessing executing unit 41 causes a test data storing unit 43 to store test data created by performing the learning-time preprocessing based on the operation-related data.

Note that details of inference-time preprocessing performed by the preprocessing executing unit 41 in the third embodiment are similar to details of the inference-time preprocessing described in the first embodiment, and thus redundant description is omitted. In the inference-time preprocessing, the preprocessing executing unit 41 does not need prior data.

The preprocessing executing unit 41 outputs the model input data created by performing the inference-time preprocessing to the prediction unit 62.

In the third embodiment, the training data acquiring unit 51 of the learning unit 5a checks whether or not prior training data is stored in the training data storing unit 42. When the prior training data is stored, the training data acquiring unit 51 acquires the prior training data and outputs the acquired prior training data to the prior learning unit 56.

In addition, the training data acquiring unit 51 acquires training data from the training data storing unit 42, and outputs the acquired training data to the noise imparting unit 52, the outlier detecting unit 53, and the model learning unit 54.

The prior learning unit 56 of the learning unit 5a causes a prior learning model to learn a relationship between an explanatory variable and an objective variable on the basis of the prior training data output from the training data acquiring unit 51.

Note that the prior learning model and the machine learning model trained by the model learning unit 54 are preferably the same type of machine learning model.

The prior learning unit 56 outputs the learned prior learning model to the model learning unit 54. The model learning unit 54 stores the prior learning model in an internal buffer or the like.

In the third embodiment, the model learning unit 54 of the learning unit 5a reads the prior learning model stored in the internal buffer or the like, calculates a loss function using a weight γ of NCP Loss set by the outlier detecting unit 53, and performs transfer learning on the machine learning model.

More specifically, the model learning unit 54 reads the prior learning model stored in the internal buffer or the like, calculates the loss function using the weight γ set by the outlier detecting unit 53, and trains the machine learning model on the basis of the training data acquired by the training data acquiring unit 51 and the noise-imparted training data created by the noise imparting unit 52.

Note that the calculation of the loss function using the weight γ of NCP Loss has been already described in the first embodiment, and thus redundant description is omitted. In addition, details of the noise imparting unit 52 and the outlier detecting unit 53 are similar to details of the noise imparting unit 52 and the outlier detecting unit 53 described in the first embodiment, and thus redundant description is omitted.

The transfer learning performed by the model learning unit 54 is a known technique, but here, the transfer learning will be briefly described.

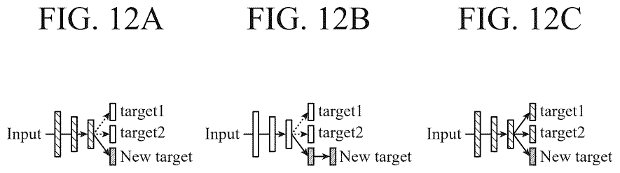

FIG. 12 is a diagram for describing an example of the transfer learning.

In FIG. 12, FIG. 12A illustrates an example of Fine Tuning, FIG. 12B illustrates an example of Feature Extraction, and FIG. 12C illustrates an example of Joint Training.

The transfer learning is a technique for adapting a model trained in a certain region to another region, and is specifically an effective method for adapting a model trained in a region where data can be widely acquired to a region having only a small amount of data or adapting a model trained by a simulator to a real environment.

As an example of the transfer learning, as illustrated in FIG. 12, there are Fine Tuning that learns only new data, Feature Extraction that performs training by adding a new layer to a model trained in advance, Joint Training capable of corresponding to a plurality of tasks, and the like.

Note that this is merely an example, and the model learning unit 54 may perform transfer learning using a transfer learning method other than these methods.

At the time of training, the model learning unit 54 can arbitrarily change a layer to be trained of a neural network, and may learn all layers or may learn only one layer.

Here, details of the outlier detecting unit 53 are similar to details of the outlier detecting unit 53 described in the first embodiment. That is, when the outlier detecting unit 53 inputs the training data acquired by the training data acquiring unit 51, more specifically, the training data created on the basis of the operation-related data to an outlier detecting mechanism and learns the training data, and trains the outlier detecting mechanism, the outlier detecting unit 53 inputs the noise-imparted training data created by the noise imparting unit 52 to the learned outlier detecting mechanism and calculates an outlier score.

However, this is merely an example, and for example, the outlier detecting unit 53 may use the prior training data for training of the outlier detecting mechanism.

Specifically, the outlier detecting unit 53 trains the outlier detecting mechanism using data including the training data and the prior training data. Then, the outlier detecting unit 53 inputs the noise-imparted training data created by the noise imparting unit 52 to the learned outlier detecting mechanism, and calculates an outlier score.

Note that, in this case, the training data acquiring unit 51 outputs the prior training data acquired from the training data storing unit 42 to the prior learning unit 56 and the outlier detecting unit 53.

When there is a large amount of prior data and there is a small amount of data of an application destination, that is, operation-related data acquired from the machine device 1, if the outlier detecting mechanism is trained with training data based on a small amount of data, when the model learning unit 54 creates a machine learning model, a machine learning model is created in which data that is only not included in the small amount of training data based on the small amount of operation-related data used for training but is originally close to the training data (specifically, noise-imparted training data) is determined to be deviated, and training of uncertainty is not correctly controlled.

The outlier detecting unit 53 trains the outlier detecting mechanism with data including the large amount of data and the small amount of data and calculates an outlier score for data obtained by imparting noise to the small amount of data, whereby it is possible to prevent occurrence of an event in which training of uncertainty is not correctly controlled as described above.

Operation of the uncertainty learning device 2b according to the third embodiment will be described.

First, learning-time operation of the uncertainty learning device 2b according to the third embodiment will be described.

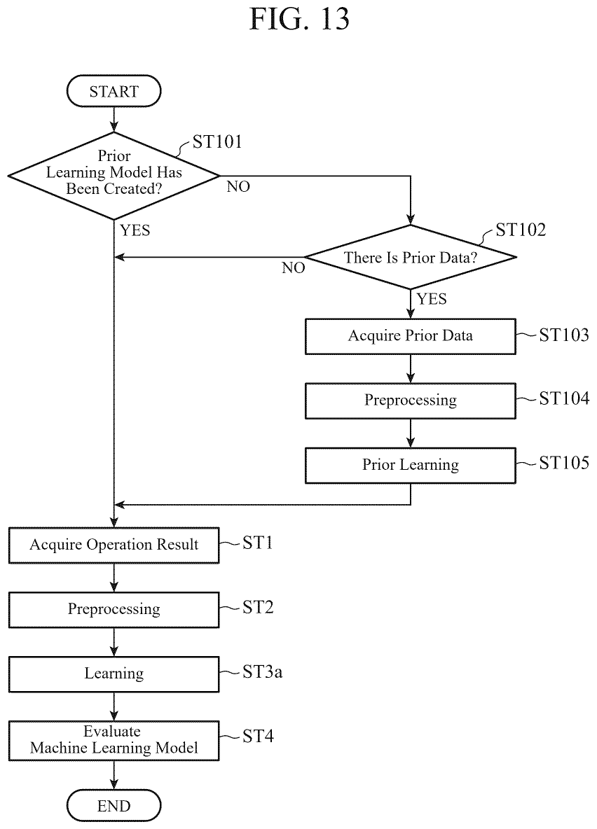

FIG. 13 is a flowchart for describing the learning-time operation of the uncertainty learning device 2b according to the third embodiment.

The uncertainty learning device 2b executes the learning-time operation as illustrated in the flowchart of FIG. 13, for example, on the basis of an instruction from a user. For example, the user operates an input device (not illustrated) and inputs an operation start instruction. When receiving the operation start instruction, a control unit (not illustrated) of the uncertainty learning device 2b causes the operation result acquiring unit 31, the preprocessing executing unit 41, the training data acquiring unit 51, the noise imparting unit 52, the outlier detecting unit 53, the model learning unit 54, the prior learning unit 56, the model reading unit 61, the test data acquiring unit 63, the evaluation unit 64, and the prior data acquiring unit 8 to start operation. For example, the user may input the operation start instruction by inputting operation-related data or prior data. The uncertainty learning device 2b repeats the learning-time operation as illustrated in the flowchart of FIG. 13, for example, until the machine learning model is evaluated to some extent or until the control unit receives an operation end instruction from the user.

Since specific contents of the processing of steps ST1, ST2, and ST4 in FIG. 13 are similar to those of the processing of steps ST1, ST2, and ST4 in FIG. 4 described in the first embodiment, respectively, redundant description is omitted.

The prior data acquiring unit 8 determines whether or not a prior learning model has been created (step ST101).

For example, a prior learning model presence flag indicating whether or not a prior learning model has been created is set at a place that can be referred to by each component of the uncertainty learning device 2b. The prior learning model presence flag indicates, for example, “1: prior learning model is present” and “0: prior learning model is absent”, and an initial value is “0”. In the uncertainty learning device 2b, when creating a prior learning model, the prior learning unit 56 sets the prior learning model presence flag to “1”.

For example, the prior data acquiring unit 8 can determine whether or not a prior learning model has been created by referring to the prior learning model presence flag.

If the prior data acquiring unit 8 determines that a prior learning model has been created (“YES” in step ST101), the operation of the uncertainty learning device 2b proceeds to processing of step ST1.

If it is determined that a prior learning model has not been created (“NO” in step ST101), the prior data acquiring unit 8 checks whether or not prior data is stored in the cloud (step ST102).

If the prior data is stored in the cloud (“YES” in step ST102), the prior data acquiring unit 8 acquires the prior data (step ST103).

The prior data acquiring unit 8 outputs the acquired prior data to a preprocessing executing unit 41 of a preprocessing unit 4.

The preprocessing executing unit 41 acquires the prior data output from the prior data acquiring unit 8 in step ST103, and performs preprocessing of shaping prior training data used by the prior learning unit 56 of the learning unit 5a, that is, learning-time preprocessing, on the basis of the prior data (step ST104).

The preprocessing executing unit 41 adds, to the prior training data, data indicating that the prior training data is training data based on the prior data, and causes the training data storing unit 42 to store the prior training data.

The training data acquiring unit 51 acquires the prior training data which the preprocessing executing unit 41 has caused the training data storing unit 42 to store in step ST104, and the prior learning unit 56 causes the prior learning model to learn a relationship between an explanatory variable and an objective variable on the basis of the prior training data acquired by the training data acquiring unit 51 (step ST105).

The prior learning unit 56 outputs the learned prior learning model to the model learning unit 54. The model learning unit 54 stores the prior learning model in an internal buffer or the like.

On the other hand, if the prior data is not stored in the cloud (“NO” in step ST102), the prior data acquiring unit 8 sets “1” in a prior learning model creation inability flag. The prior learning model creation inability flag is a flag indicating that the prior learning model cannot be created, and is set at a place that can be referred to by each component of the uncertainty learning device 2b. The prior learning model creation inability flag indicates, for example, “1: a prior learning model cannot be created” and “0: a prior learning model can be created”, and an initial value of the prior learning model creation inability flag is “0”. Thereafter, the operation of the uncertainty learning device 2b proceeds to processing of step ST1.

In step ST3a, the learning unit 5a performs transfer learning to create a machine learning model on the basis of the training data stored in the training data storing unit 42, the noise-imparted training data created on the basis of the training data, and the prior learning model created by the prior learning unit 56 in step ST105 (step ST3a).

The learning unit 5 causes the model storing unit 55 to store the created machine learning model.

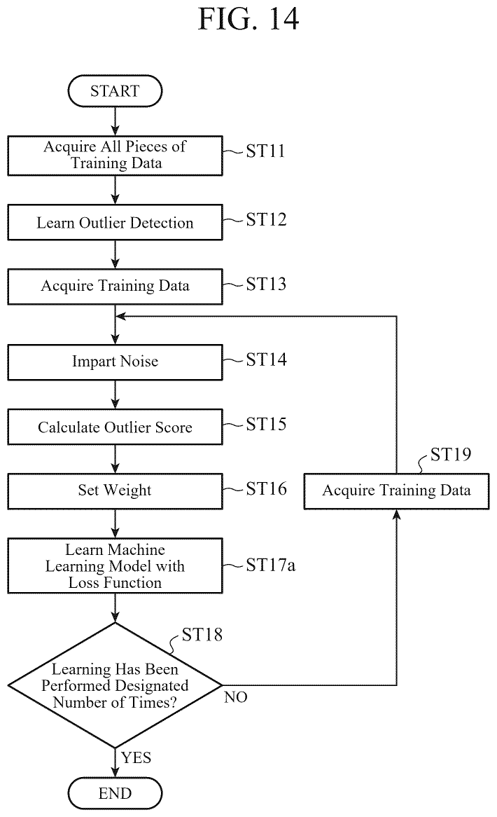

FIG. 14 is a flowchart for describing details of processing of step ST3a in FIG. 13.

Since specific contents of the processing of steps ST11 to ST16, ST18, and ST19 in FIG. 14 are similar to those of the processing of steps ST11 to ST16, ST18, and ST19 in FIG. 5 described in the first embodiment, respectively, redundant description is omitted.

When the prior learning model has been created, the model learning unit 54 reads the prior learning model stored in an internal buffer or the like, calculates a loss function using the read prior learning model, the training data acquired in step ST13, the noise-imparted training data created in step ST14, and the weight γ of NCP Loss set by the outlier detecting unit 53 in step ST16, and performs transfer learning on the machine learning model (step ST17a).

When the prior learning model has not been created, the model learning unit 54 calculates a loss function using the training data acquired in step ST13, the noise-imparted training data created in step ST14, and the weight γ of NCP Loss set by the outlier detecting unit 53 in step ST16, and trains the machine learning model.

The model learning unit 54 can determine whether or not the prior learning model has been created, for example, from the prior learning model presence flag and the prior learning model creation inability flag. For example, when the prior learning model presence flag is “0” and the prior learning model creation inability flag is “0”, the model learning unit 54 may postpone execution of the processing of step ST17a until “1” is set to the prior learning model presence flag, in other words, until the prior learning model is created.

Note that, as described above, for example, the outlier detecting unit 53 may use the prior training data for training of the outlier detecting mechanism.

In this case, in step ST12 illustrated in the flowchart of FIG. 14, the outlier detecting unit 53 trains the outlier detecting mechanism using data including the training data and the prior training data. Then in step ST15, the outlier detecting unit 53 inputs the noise-imparted training data created by the noise imparting unit 52 in step ST14 to the outlier detecting mechanism trained in step ST12, and calculates an outlier score.

In step ST11, the training data acquiring unit 51 outputs the prior training data acquired from the training data storing unit 42 to the outlier detecting unit 53.

Since inference-time operation of the uncertainty learning device 2b according to the third embodiment is similar to the inference-time operation of the uncertainty learning device 2 according to the first embodiment described with reference to the flowchart of FIG. 6 in the first embodiment, redundant description is omitted.

As described above, the uncertainty learning device 2b acquires the prior data based on the simulation data obtained by performing simulation operation on the machine device 1 or the operation-related data related to a past operation result of the machine device 1, and trains the prior learning model on the basis of the prior training data created on the basis of the acquired prior data. Then, the uncertainty learning device 2b calculates a weighted loss function based on the calculated outlier score, and performs transfer learning on the prior learning model on the basis of the training data and the noise-imparted training data.

When the machine learning model is created, if the training data is not prepared to some extent, the machine learning model may be a machine learning model in which inference of a predicted value and uncertainty cannot be performed well, and as a result, inference accuracy may deteriorate when inference based on unknown data (here, model input data based on operation-related data) is actually performed. On the other hand, by creating a prior learning model of a machine learning model and performing transfer learning by utilizing past operation-related data obtained in advance or simulation data obtained from a simulator, the uncertainty learning device 2b can provide a machine learning model that can infer a predicted value and uncertainty well, and has highly accurate even when there is a small amount of operation-related data obtained from the machine device 1, training data for creating a machine learning model being created from the operation-related data.

Note that, in the third embodiment described above, the uncertainty learning device 2b includes the acquisition unit 3, the preprocessing unit 4, the inference unit 6, and the prior data acquiring unit 8, but this is merely an example.

The uncertainty learning device 2b only needs to include at least the learning unit 5a, and for example, the acquisition unit 3, the preprocessing unit 4, the inference unit 6, and the prior data acquiring unit 8 may be arranged at a place that can be referred to by the uncertainty learning device 2b outside the uncertainty learning device 2b.

When the uncertainty learning device 2b does not include the acquisition unit 3, the preprocessing unit 4, the inference unit 6, and the prior data acquiring unit 8, the processing of steps ST101 to ST105, ST1, ST2, and ST4 can be omitted in the operation of the uncertainty learning device 2b described with reference to the flowchart of FIG. 13. In addition, the uncertainty learning device 2b can omit the inference-time operation as illustrated in the flowchart of FIG. 6.

In addition, in the third embodiment described above, the uncertainty learning device 2b is included in the server, but this is merely an example.

For example, the uncertainty learning device 2b may be included in the machine device 1.

In addition, for example, in the uncertainty learning device 2b, some or all of the operation result acquiring unit 31, the preprocessing executing unit 41, the training data acquiring unit 51, the noise imparting unit 52, the outlier detecting unit 53, the model learning unit 54, the prior learning unit 56, the model reading unit 61, the prediction unit 62, the test data acquiring unit 63, the evaluation unit 64, and the prior data acquiring unit 8 may be included in a device or the like outside the server.

In addition, in the third embodiment described above, the machine device 1 is an FA device, but this is merely an example. For example, the machine device 1 can be any one of various devices that solve various tasks using a machine learning model, such as a control device that performs automatic driving control of a mobile object and a medical device used at a medical site.

Since a hardware configuration of the uncertainty learning device 2b according to the third embodiment is the configuration described with reference to FIGS. 7A and 7B in the first embodiment, description thereof is omitted.

In the third embodiment, functions of the operation result acquiring unit 31, the preprocessing executing unit 41, the training data acquiring unit 51, the noise imparting unit 52, the outlier detecting unit 53, the model learning unit 54, the prior learning unit 56, the model reading unit 61, the prediction unit 62, the test data acquiring unit 63, the evaluation unit 64, the prior data acquiring unit 8, and the control unit (not illustrated) are implemented by the processing circuit 1001. That is, that is, the uncertainty learning device 2b includes the processing circuit 1001 for performing control to create a machine learning model capable of inferring uncertainty more accurately by creating a prior learning model on the basis of prior data and performing transfer learning so that uncertainty is high for extrapolation data and the uncertainty is low for data close to the training data due to the weight γ set on the basis of an outlier score.

The processing circuit 1001 may be dedicated hardware as illustrated in FIG. 7A, or the processor 1004 that executes a program stored in the memory as illustrated in FIG. 7B.

By reading and executing the program stored in the memory 1005, the processing circuit 1001 executes the functions of the operation result acquiring unit 31, the preprocessing executing unit 41, the training data acquiring unit 51, the noise imparting unit 52, the outlier detecting unit 53, the model learning unit 54, the prior learning unit 56, the model reading unit 61, the prediction unit 62, the test data acquiring unit 63, the evaluation unit 64, the prior data acquiring unit 8, and the control unit (not illustrated). That is, the uncertainty learning device 2b includes the memory 1005 for storing a program that causes the above-described steps ST101 to ST105 and ST1 to ST4 illustrated in FIG. 13 or the above-described steps ST10 to ST50 illustrated in FIG. 6 to be executed as a result when the program is executed by the processing circuit 1001. In addition, it can also be said that the program stored in the memory 1005 causes a computer to execute a processing procedure or method performed by the operation result acquiring unit 31, the preprocessing executing unit 41, the training data acquiring unit 51, the noise imparting unit 52, the outlier detecting unit 53, the model learning unit 54, the prior learning unit 56, the model reading unit 61, the prediction unit 62, the test data acquiring unit 63, the evaluation unit 64, the prior data acquiring unit 8, and the control unit (not illustrated).

Each of the operation result storing unit 32, the training data storing unit 42, the test data storing unit 43, and the model storing unit 55 is constituted by, for example, an HDD or an SSD.

In addition, the uncertainty learning device 2b includes the input interface device 1002 and the output interface device 1003 that perform wired communication or wireless communication with a device such as the machine device 1.

As described above, the uncertainty learning device 2b according to the third embodiment includes: the prior data acquiring unit 8 that acquires prior data based on simulation data obtained by performing simulation operation on the machine device 1 or operation-related data related to a past operation result of the machine device 1; and the prior learning unit 56 that trains a prior learning model on the basis of prior training data created on the basis of prior data acquired by the prior data acquiring unit 8, and the model learning unit 54 creates a machine learning model by calculating a weighted loss function based on an outlier score calculated by the outlier detecting unit 53, and performing transfer learning on the prior learning model trained by the prior learning unit 56 on the basis of training data and noise-imparted training data.

By creating a prior learning model of a machine learning model by utilizing past operation-related data obtained in advance or simulation data obtained from a simulator, the uncertainty learning device 2b can provide a machine learning model that can infer a predicted value and uncertainty well, and has highly accurate even when there is a small amount of operation-related data obtained from the machine device 1, training data for creating a machine learning model being created from the operation-related data.

### Fourth Embodiment

In the third embodiment, the uncertainty learning device creates the prior learning model on the basis of the prior data, and creates the machine learning model by transfer learning using the created prior learning model.

In a fourth embodiment, an embodiment will be further described in which transfer learning is performed by utilizing sensor data acquired by an external sensor, which cannot be acquired by a machine device, and a machine learning model is created.

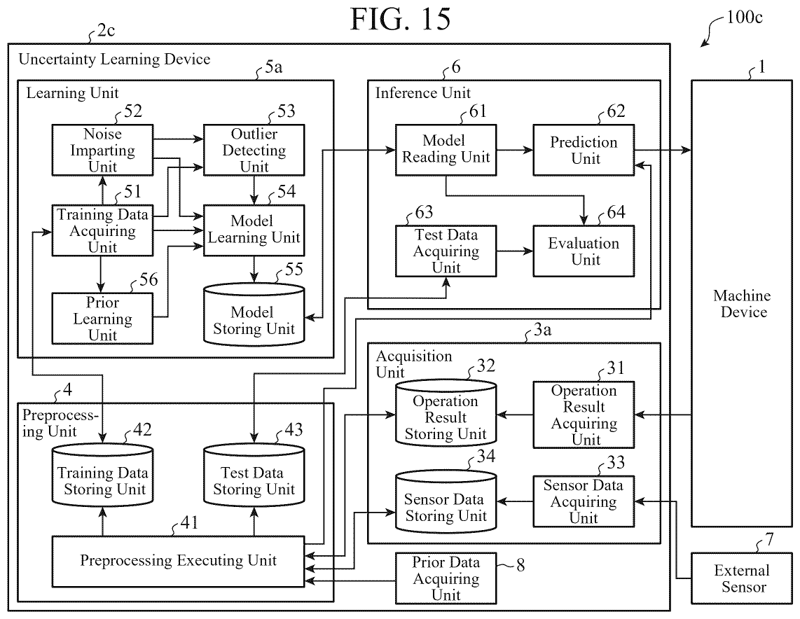

FIG. 15 is a diagram illustrating a configuration example of an uncertainty learning system 100c including an uncertainty learning device 2c according to the fourth embodiment.

The uncertainty learning system 100c includes the uncertainty learning device 2c, a machine device 1, and an external sensor 7. The uncertainty learning device 2c is connected to the machine device 1 and an external sensor 7 via a network. Since the external sensor 7 has been described in the second embodiment, redundant description is omitted.

In the fourth embodiment, the machine device 1 is assumed to be, for example, an FA device.

The uncertainty learning device 2c according to the fourth embodiment is included in, for example, a server.

In a configuration example of the uncertainty learning device 2c according to the fourth embodiment, similar components to those of the configuration example of the uncertainty learning device 2b according to the third embodiment described with reference to FIG. 11 are denoted by the same reference numerals, and redundant description is omitted.

The configuration example of the uncertainty learning device 2c is different from the configuration example of the uncertainty learning device 2b according to the third embodiment in that an acquisition unit 3a includes a sensor data acquiring unit 33 and a sensor data storing unit 34 in addition to an operation result acquiring unit 31 and an operation result storing unit 32.

Details of the acquisition unit 3a are similar to details of the acquisition unit 3a included in the uncertainty learning device 2a described in the second embodiment, and thus duplicate description is omitted.

Note that, in the fourth embodiment, similarly to the uncertainty learning device 2b according to the third embodiment, the uncertainty learning device 2c performs “learning” of creating a machine learning model and “inference” of inferring a predicted value and uncertainty using the machine learning model created by “learning”.

In the fourth embodiment, when prior data is output from a prior data acquiring unit 8, the preprocessing executing unit 41 acquires the prior data, and performs learning-time preprocessing of shaping prior training data used by a prior learning unit 56 of a learning unit 5a on the basis of the prior data.

In addition, the preprocessing executing unit 41 acquires operation-related data acquired by the operation result acquiring unit 31 from the operation result storing unit 32, acquires sensor data acquired by the sensor data acquiring unit 33 from the sensor data storing unit 34, and performs learning-time preprocessing of shaping training data used by a model learning unit 54 of the learning unit 5 and test data used by an evaluation unit 64 of an inference unit 6 on the basis of the operation-related data and the sensor data. More specifically, the preprocessing executing unit 41 adds the sensor data obtained by the external sensor 7 to an explanatory variable.

Details of the learning-time preprocessing of shaping the prior training data on the basis of the prior data and details of the learning-time preprocessing of shaping the training data and the test data on the basis of the operation-related data and the sensor data, which are performed by the preprocessing executing unit 41, have already been described in the second embodiment or the third embodiment, and thus redundant description is omitted.

The preprocessing executing unit 41 adds, to the prior training data created by performing the learning-time preprocessing based on the prior data, data indicating that the training data is training data based on the prior data, and causes a training data storing unit 42 to store the prior training data.

In addition, when creating the training data by performing the learning-time preprocessing based on the operation-related data, the preprocessing executing unit 41 adds, to the created training data, data indicating that the training data is training data based on the operation-related data, and causes the training data storing unit 42 to store the training data. In addition, the preprocessing executing unit 41 causes the test data storing unit 43 to store the test data created by performing the learning-time preprocessing.

Note that details of inference-time preprocessing performed by the preprocessing executing unit 41 in the fourth embodiment are similar to details of the inference-time preprocessing described in the second embodiment, and thus redundant description is omitted. In the inference-time preprocessing, the preprocessing executing unit 41 does not need prior data.

The preprocessing executing unit 41 outputs the model input data created by performing the inference-time preprocessing to the prediction unit 62.

By reading the prior learning model created by the prior learning unit 56, stored in an internal buffer or the like, calculating a loss function using a weight γ of NCP Loss set by the outlier detecting unit 53 on the basis of training data including an explanatory variable based on the sensor data, and performing transfer learning on a machine learning model, the model learning unit 54 of the learning unit 5a creates a machine learning model.

Since details of the prior learning unit 56 have been described in the third embodiment, redundant description is omitted. In addition, since details of the transfer learning performed by the model learning unit 54 have been described in the third embodiment, redundant description is omitted.

The model learning unit 54 creates one machine learning model on the basis of the training data created by the preprocessing executing unit 41 on the basis of the operation-related data and the sensor data and one prior learning model created by the prior learning unit 56.

Note that this is merely an example, and for example, the prior learning unit 56 may create a prior learning model for each content of the sensor data, and the model learning unit 54 may create a machine learning model obtained by performing transfer learning on the prior learning model for each content of the sensor data.

For example, when the prior data acquiring unit 8 can acquire simulation data having the same contents as the sensor data acquired by the sensor data acquiring unit 33 from the external sensor 7 as the prior data, the prior learning unit 56 may create a prior learning model for each content of the sensor data, and the model learning unit 54 may create a machine learning model obtained by performing transfer learning on the prior learning model for each content of the sensor data.

In this case, for example, in the learning-time preprocessing, the preprocessing executing unit 41 creates prior training data grouped on the basis of data (simulation data) having the same contents as the sensor data and included in the prior data. Hereinafter, the simulation data having the same contents as the sensor data and included in the prior data is also referred to as “model classification prior data”. The preprocessing executing unit 41 associates the model classification prior data with the created prior training data.

In addition, the preprocessing executing unit 41 creates training data and test data grouped on the basis of the contents of the sensor data in the learning-time preprocessing. The preprocessing executing unit 41 associates sensor data with each of the created training data and test data.

The prior learning unit 56 creates a prior learning model for each piece of prior training data grouped with the model classification prior data. The prior learning unit 56 outputs the created prior learning model to the model learning unit 54 in association with the model classification prior data associated with the prior training data from which the prior learning model is created.

The model learning unit 54 reads a prior learning model corresponding to a content of the sensor data associated with the training data acquired from the training data acquiring unit 51 as a prior learning model used for transfer learning, calculates a loss function using the read prior learning model and a weight γ of NCP Loss set by the outlier detecting unit 53, and performs transfer learning on the machine learning model. The model learning unit 54 causes the model storing unit 55 to store the created machine learning model and the sensor data in association with each other.

Note that, as described above, since the prior data acquiring unit 8 outputs the prior learning model to the model learning unit 54 in association with the model classification prior data associated with the prior training data from which the prior learning model is created, the model learning unit 54 can specify a prior learning model corresponding to a content of the sensor data associated with the training data on the basis of the model classification prior data associated with the prior learning model.

In the inference unit 6, a model reading unit 61 reads a machine learning model corresponding to the test data grouped on the basis of the contents of the sensor data.

The evaluation unit 64 of the inference unit 6 evaluates the machine learning model corresponding to the sensor data associated with the test data using the test data acquired by the test data acquiring unit 63.

By inputting the model input data created by the preprocessing executing unit 41 in the inference-time preprocessing to the machine learning model corresponding to the sensor data associated with the model input data, the prediction unit 62 of the inference unit 6 obtains a predicted value and uncertainty, thereby inferring the predicted value and the uncertainty. Note that, when the machine learning model is created for each type of the sensor data, the preprocessing executing unit 41 creates model input data for each content of the sensor data in the inference-time preprocessing, and outputs the created model input data and the sensor data to the prediction unit 62 in association with each other.

Also in the fourth embodiment, similarly to the third embodiment, the outlier detecting unit 53 may use the prior training data for training of the outlier detecting mechanism.

Operation of the uncertainty learning device 2c according to the fourth embodiment will be described.

First, learning-time operation of the uncertainty learning device 2c according to the fourth embodiment will be described.

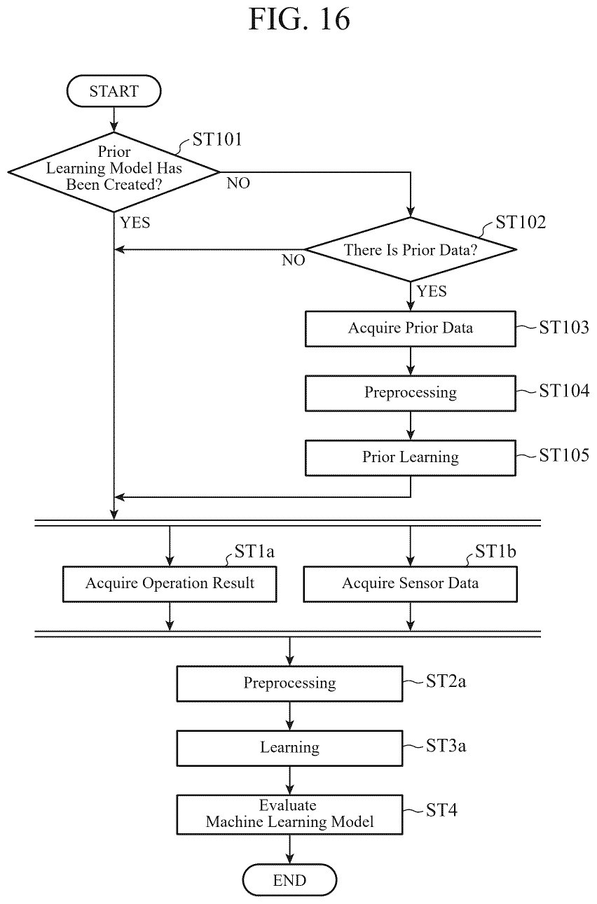

FIG. 16 is a flowchart for describing operation of the uncertainty learning device 2c according to the fourth embodiment.

Note that the operation of the uncertainty learning device 2c illustrated in FIG. 16 is operation when the learning unit 5a creates one machine learning model in the uncertainty learning device 2c.

The uncertainty learning device 2c executes the learning-time operation as illustrated in the flowchart of FIG. 16, for example, on the basis of an instruction from a user. For example, the user operates an input device (not illustrated) and inputs an operation start instruction. When receiving the operation start instruction, a control unit (not illustrated) of the uncertainty learning device 2c causes the operation result acquiring unit 31, the sensor data acquiring unit 33, the preprocessing executing unit 41, the training data acquiring unit 51, the noise imparting unit 52, the outlier detecting unit 53, the model learning unit 54, the prior learning unit 56, the model reading unit 61, the test data acquiring unit 63, the evaluation unit 64, and the prior data acquiring unit 8 to start operation. For example, the user may input the operation start instruction by inputting operation-related data. The uncertainty learning device 2c repeats the learning-time operation as illustrated in the flowchart of FIG. 16, for example, until the machine learning model is evaluated to some extent or until the control unit receives an operation end instruction from the user.

Since specific contents of the processing of steps ST101 to ST105 and ST3a in FIG. 16 are similar to those of the processing of ST101 to ST105 and ST3a in FIG. 13 described in the third embodiment, respectively, redundant description is omitted. In addition, since specific contents of the processing of steps ST1a, ST1b, ST2a, and ST4 in FIG. 16 are similar to those of the processing of steps ST1a, ST1b, ST2a, and ST4 in FIG. 9 described in the second embodiment, respectively, redundant description is omitted. Note that the processing of step ST3a in FIG. 16 in the uncertainty learning device 2c is specifically the processing as illustrated in the flowchart of FIG. 14. Since operation of the uncertainty learning device 2c illustrated in the flowchart of FIG. 14, more specifically, the model learning unit 54 has been described in the third embodiment, redundant description is omitted.

Note that, for example, when the learning unit 5a, more specifically, the model learning unit 54 of the learning unit 5a creates a machine learning model for each content of the sensor data, in step ST104, the preprocessing executing unit 41 creates data having the same contents as the sensor data included in the prior data, in other words, prior training data grouped on the basis of the model classification prior data in the learning-time preprocessing. In addition, in step ST2a, the preprocessing executing unit 41 creates training data and test data grouped on the basis of the contents of the sensor data in the learning-time preprocessing.

The prior learning unit 56 creates a prior learning model for each piece of the grouped prior training data in step ST105. The prior learning unit 56 outputs the created prior learning model to the model learning unit 54 in association with the model classification prior data included in the prior training data from which the prior learning model is created.

In step ST3a, more specifically in step ST17a in FIG. 14, the model learning unit 54 reads a prior learning model corresponding to the sensor data associated with the training data acquired from the training data acquiring unit 51 as a prior learning model used for transfer learning, calculates a loss function using the read prior learning model and a weight γ of NCP Loss set by the outlier detecting unit 53, and performs transfer learning on the machine learning model.

In step ST4, the model reading unit 61 of the inference unit 6 reads a machine learning model corresponding to the sensor data, and the evaluation unit 64 evaluates the machine learning model corresponding to a content of the sensor data associated with the test data using the test data acquired by the test data acquiring unit 63.

Since inference-time operation of the uncertainty learning device 2c according to the fourth embodiment is similar to the inference-time operation of the uncertainty learning device 2a according to the second embodiment described with reference to the flowchart of FIG. 10 in the second embodiment, redundant description is omitted.

As described above, the uncertainty learning device 2c acquires the prior data based on the operation result-related simulation data obtained by performing simulation operation on the machine device 1 or the operation-related data related to a past operation result of the machine device 1, and trains the prior learning model on the basis of the prior training data created on the basis of the prior data.

The uncertainty learning device 2c acquires the sensor data acquired by the external sensor 7 disposed independently of the machine device 1, and acquires training data created on the basis of the operation-related data obtained from the machine device 1 and the sensor data.

Then, by calculating a weighted loss function based on the outlier score and performing transfer learning on the prior learning model on the basis of the training data and the noise-imparted training data, the uncertainty learning device 2c creates a machine learning model.

By creating a machine learning model capable of recognizing a difference in operation-related data caused by a difference in conditions when an operation result, in other words, the operation-related data is obtained, the uncertainty learning device 2c can provide a machine learning model in which inference accuracy of uncertainty is further improved, and by creating a prior learning model of a machine learning model by utilizing past operation-related data obtained in advance or simulation data obtained from a simulator, the uncertainty learning device 2c can provide a machine learning model that can infer a predicted value and uncertainty well, and has highly accurate even when there is a small amount of operation-related data obtained from the machine device 1, training data for creating a machine learning model being created from the operation-related data.

In addition, the uncertainty learning device 2c may group the prior data into groups corresponding to data having the same contents as the sensor data included in the prior data, may create the grouped prior training data, and may create a prior learning model for each piece of the grouped prior training data. Then, by calculating a weighted loss function based on an outlier score on the basis of the training data created on the basis of the operation-related data obtained from the machine device 1 and the sensor data acquired from the external sensor 7 and the noise-imparted training data, and performing transfer learning on the prior learning model corresponding to the sensor data, the uncertainty learning device 2c may create a machine learning model.

As a result, the uncertainty learning device 2c can select a machine learning model appropriate for transfer learning, and can provide a machine learning model in which inference accuracy of uncertainty is further improved.

Note that, in the fourth embodiment described above, the uncertainty learning device 2c includes the acquisition unit 3a, the preprocessing unit 4, the inference unit 6, and the prior data acquiring unit 8, but this is merely an example.

The uncertainty learning device 2c only needs to include at least the learning unit 5a, and for example, the acquisition unit 3a, the preprocessing unit 4, the inference unit 6, and the prior data acquiring unit 8 may be arranged at a place that can be referred to by the uncertainty learning device 2c outside the uncertainty learning device 2c.

When the uncertainty learning device 2c does not include the acquisition unit 3a, the preprocessing unit 4, the inference unit 6, and the prior data acquiring unit 8, the processing of steps ST101 to ST105, ST1a, ST1b, ST2a, and ST4 can be omitted in the operation of the uncertainty learning device 2c described with reference to the flowchart of FIG. 16. In addition, the uncertainty learning device 2c can omit the inference-time operation described with reference to the flowchart of FIG. 10.

In addition, in the fourth embodiment described above, the uncertainty learning device 2c is included in the server, but this is merely an example.

For example, the uncertainty learning device 2c may be included in the machine device 1.

In addition, for example, in the uncertainty learning device 2c, some or all of the operation result acquiring unit 31, the sensor data acquiring unit 33, the preprocessing executing unit 41, the training data acquiring unit 51, the noise imparting unit 52, the outlier detecting unit 53, the model learning unit 54, the prior learning unit 56, the model reading unit 61, the prediction unit 62, the test data acquiring unit 63, the evaluation unit 64, and the prior data acquiring unit 8 may be included in a device or the like outside the server.

In addition, in the fourth embodiment described above, the machine device 1 is an FA device, but this is merely an example. For example, the machine device 1 can be any one of various devices that solve various tasks using a machine learning model, such as a control device that performs automatic driving control of a mobile object and a medical device used at a medical site.

Since a hardware configuration of the uncertainty learning device 2c according to the fourth embodiment is the configuration described with reference to FIGS. 7A and 7B in the first embodiment, description thereof is omitted.

In the fourth embodiment, functions of the operation result acquiring unit 31, the sensor data acquiring unit 33, the preprocessing executing unit 41, the training data acquiring unit 51, the noise imparting unit 52, the outlier detecting unit 53, the model learning unit 54, the prior learning unit 56, the model reading unit 61, the prediction unit 62, the test data acquiring unit 63, the evaluation unit 64, the prior data acquiring unit 8, and the control unit (not illustrated) are implemented by a processing circuit 1001. That is, the uncertainty learning device 2c includes the processing circuit 1001 for performing control to create a machine learning model capable of inferring uncertainty more accurately by creating a prior learning model on the basis of prior data and performing transfer learning so that uncertainty is high for extrapolation data and the uncertainty is low for data close to the training data due to the weight γ set on the basis of the prior learning model and an outlier score, and capable of recognizing a difference in operation-related data caused by a difference in conditions when the operation-related data is obtained.

The processing circuit 1001 may be dedicated hardware as illustrated in FIG. 7A, or the processor 1004 that executes a program stored in the memory as illustrated in FIG. 7B.

By reading and executing the program stored in the memory 1005, the processing circuit 1001 executes the functions of the operation result acquiring unit 31, the sensor data acquiring unit 33, the preprocessing executing unit 41, the training data acquiring unit 51, the noise imparting unit 52, the outlier detecting unit 53, the model learning unit 54, the prior learning unit 56, the model reading unit 61, the prediction unit 62, the test data acquiring unit 63, the evaluation unit 64, the prior data acquiring unit 8, and the control unit (not illustrated). That is, the uncertainty learning device 2c includes the memory 1005 for storing a program that causes the above-described steps ST101 to ST105, ST1a, and ST1b to ST4 illustrated in FIG. 16 or the above-described steps ST10a and ST10b to ST50 illustrated in FIG. 10 to be executed as a result when the program is executed by the processing circuit 1001. In addition, it can also be said that the program stored in the memory 1005 causes a computer to execute a processing procedure or method performed by the operation result acquiring unit 31, the sensor data acquiring unit 33, the preprocessing executing unit 41, the training data acquiring unit 51, the noise imparting unit 52, the outlier detecting unit 53, the model learning unit 54, the prior learning unit 56, the model reading unit 61, the prediction unit 62, the test data acquiring unit 63, the evaluation unit 64, the prior data acquiring unit 8, and the control unit (not illustrated).

Each of the operation result storing unit 32, the sensor data storing unit 34, the training data storing unit 42, the test data storing unit 43, and the model storing unit 55 is constituted by, for example, an HDD or an SSD.

In addition, the uncertainty learning device 2c includes the input interface device 1002 and the output interface device 1003 that perform wired communication or wireless communication with a device such as the machine device 1.

As described above, the uncertainty learning device 2c according to the fourth embodiment includes: the prior data acquiring unit 8 that acquires prior data based on operation result-related simulation data obtained by performing simulation operation on the machine device 1 or operation-related data related to a past operation result of the machine device 1; the prior learning unit 56 that trains a prior learning model on the basis of prior training data created on the basis of prior data acquired by the prior data acquiring unit 8; and the sensor data acquiring unit 33 that acquires sensor data acquired by the external sensor 7 disposed independently of the machine device 1, the training data acquiring unit 51 acquires training data created on the basis of operation-related data obtained from the machine device 1 and sensor data acquired by the sensor data acquiring unit 33, and the model learning unit 54 creates a machine learning model by calculating a weighted loss function based on an outlier score calculated by the outlier detecting unit 53, and performing transfer learning on the prior learning model trained by the prior learning unit 56 on the basis of training data and noise-imparted training data.

By creating a machine learning model capable of recognizing a difference in operation-related data caused by a difference in conditions when an operation result, in other words, the operation-related data is obtained, the uncertainty learning device 2c can provide a machine learning model in which inference accuracy of uncertainty is further improved, and by creating a prior learning model of a machine learning model by utilizing past operation-related data obtained in advance or simulation data obtained from a simulator, the uncertainty learning device 2c can provide a machine learning model that can infer a predicted value and uncertainty well, and has highly accurate even when there is a small amount of operation-related data obtained from the machine device 1, training data for creating a machine learning model being created from the operation-related data.

Note that the embodiments can be freely combined to each other, any constituent element in each of the embodiments can be modified, or any constituent element in each of the embodiments can be omitted.

Hereinafter, various aspects of the present disclosure will be collectively described as Supplementary Notes.

### (Supplementary Note 1)

An uncertainty learning device that creates a machine learning model that receives, as an input, data based on operation-related data related to an operation result of a machine device and outputs a predicted value corresponding to the operation-related data and uncertainty of the predicted value, the uncertainty learning device including:
a training data acquiring unit that acquires training data created on the basis of the operation-related data obtained from the machine device;
a noise imparting unit that creates noise-imparted training data in which noise is imparted to the training data acquired by the training data acquiring unit;
an outlier detecting unit that calculates an outlier score from the training data acquired by the training data acquiring unit and the noise-imparted training data created by the noise imparting unit; and
a model learning unit that calculates a weighted loss function based on the outlier score calculated by the outlier detecting unit, and trains the machine learning model on the basis of the training data and the noise-imparted training data.

### (Supplementary Note 2)

The uncertainty learning device according to Supplementary Note 1, further including:
a test data acquiring unit that acquires test data created on the basis of the operation-related data obtained from the machine device; and
an evaluation unit that evaluates the machine learning model by inferring the predicted value and the uncertainty on the basis of the test data acquired by the test data acquiring unit and the machine learning model created by the model learning unit.

### (Supplementary Note 3)

The uncertainty learning device according to Supplementary Note 1, further including a preprocessing executing unit that creates the training data on the basis of the operation-related data, in which
the training data acquiring unit acquires the training data created by the preprocessing executing unit.

### (Supplementary Note 4)

The uncertainty learning device according to Supplementary Note 2, further including a preprocessing executing unit that creates the training data and the test data on the basis of the operation-related data, in which
the training data acquiring unit acquires the training data created by the preprocessing executing unit, and
the test data acquiring unit acquires the test data created by the preprocessing executing unit.

### (Supplementary Note 5)

The uncertainty learning device according to any one of Supplementary Notes 1 to 4, in which
the uncertainty is represented by a variance or a standard deviation indicating a variation in data.

### (Supplementary Note 6)

The uncertainty learning device according to any one of Supplementary Notes 1 to 5, further including:
a prior data acquiring unit that acquires prior data based on simulation data obtained by performing simulation operation on the machine device or the operation-related data related to the past operation result of the machine device; and
a prior learning unit that trains a prior learning model on the basis of prior training data created on the basis of the prior data acquired by the prior data acquiring unit, in which
the model learning unit creates the machine learning model by calculating a weighted loss function based on the outlier score calculated by the outlier detecting unit, and performing transfer learning on the prior learning model trained by the prior learning unit on the basis of the training data and the noise-imparted training data.

### (Supplementary Note 7)

The uncertainty learning device according to any one of Supplementary Notes 1 to 5, further including a sensor data acquiring unit that acquires sensor data acquired by an external sensor disposed independently of the machine device, in which
the training data acquiring unit acquires the training data created on the basis of the operation-related data acquired from the machine device and the sensor data acquired by the sensor data acquiring unit.

### (Supplementary Note 8)

The uncertainty learning device according to any one of Supplementary Notes 1 to 5, further including:
a prior data acquiring unit that acquires prior data based on the operation result-related simulation data obtained by performing simulation operation on the machine device or the operation-related data related to the past operation result of the machine device;
a prior learning unit that trains a prior learning model on the basis of prior training data created on the basis of the prior data acquired by the prior data acquiring unit; and
a sensor data acquiring unit that acquires sensor data acquired by an external sensor disposed independently of the machine device, in which
the training data acquiring unit acquires the training data created on the basis of the operation-related data obtained from the machine device and the sensor data acquired by the sensor data acquiring unit, and
the model learning unit creates the machine learning model by calculating a weighted loss function based on the outlier score calculated by the outlier detecting unit, and performing transfer learning on the prior learning model trained by the prior learning unit on the basis of the training data and the noise-imparted training data.

### (Supplementary Note 9)

The uncertainty learning device according to any one of Supplementary Notes 1 to 8, in which
the machine device is an FA device, and the operation-related data includes a command position, a command speed, a command acceleration, a feedback speed, a feedback acceleration, a current value, or a value obtained by measuring a deviation of a processing position.

### (Supplementary Note 10)

An uncertainty learning program that creates a machine learning model that receives, as an input, data based on operation-related data related to an operation result of a machine device and outputs a predicted value corresponding to the operation-related data and uncertainty of the predicted value, the uncertainty learning program being used for causing a computer to function as:
a training data acquiring unit that acquires training data created on the basis of the operation-related data obtained from the machine device;
a noise imparting unit that creates noise-imparted training data in which noise is imparted to the training data acquired by the training data acquiring unit;
an outlier detecting unit that calculates an outlier score from the training data acquired by the training data acquiring unit and the noise-imparted training data created by the noise imparting unit; and
a model learning unit that calculates a weighted loss function based on the outlier score calculated by the outlier detecting unit, and trains the machine learning model on the basis of the training data and the noise-imparted training data.

### (Supplementary Note 11)

An uncertainty learning system including:
the uncertainty learning device according to any one of Supplementary Notes 1 to 9; and
the machine device.

### INDUSTRIAL APPLICABILITY

The uncertainty learning device according to the present disclosure can provide a machine learning model capable of inferring a predicted value and uncertainty, and capable of inferring uncertainty more accurately as compared with a machine learning model created by a conventional method for training a machine learning model by imparting noise to all pieces of training data.

### REFERENCE SIGNS LIST

1: machine device, 2, 2a, 2b, 2c: uncertainty learning device, 3, 3a: acquisition unit, 31: operation result acquiring unit, 32: operation result storing unit, 33: sensor data acquiring unit, 34: sensor data storing unit, 4: preprocessing unit, 41: preprocessing executing unit, 42: training data storing unit, 43: test data storing unit, 5, 5a: learning unit, 51: training data acquiring unit, 52: noise imparting unit, 53: outlier detecting unit, 54: model learning unit, 55: model storing unit, 56: prior learning unit, 6: inference unit, 61: model reading unit, 62: prediction unit, 63: test data acquiring unit, 64: evaluation unit, 7: external sensor, 8: prior data acquiring unit, 100, 100a, 100b, 100c: uncertainty learning system, 1001: processing circuit, 1002: input interface device, 1003: output interface device, 1004: processor, 1005: memory

1. An uncertainty learning device to create a machine learning model to receive, as an input, data based on operation-related data related to an operation result of a machine device and to output a predicted value corresponding to the operation-related data and uncertainty of the predicted value, the uncertainty learning device comprising:
a processor; and
a memory storing a program, upon executed by the processor, to perform a process:
to acquire training data created on a basis of the operation-related data obtained from the machine device;
to create noise-imparted training data in which noise is imparted to the training data acquired;
to calculate an outlier score from the training data acquired and the noise-imparted training data created; and
to calculate a weighted loss function based on the outlier score calculated, and to train the machine learning model on a basis of the training data and the noise-imparted training data.

2. The uncertainty learning device according to claim 1, the process further comprising:
to acquire test data created on a basis of the operation-related data obtained from the machine device; and
to evaluate the machine learning model by inferring the predicted value and the uncertainty on a basis of the test data acquired and the machine learning model created.

3. The uncertainty learning device according to claim 1, the process further comprising to create the training data on a basis of the operation-related data, wherein
the process acquires the training data created.

4. The uncertainty learning device according to claim 2, the process further comprising to create the training data and the test data on a basis of the operation-related data, wherein
the process acquires the training data, and
the process acquires the test data created.

5. The uncertainty learning device according to claim 1, wherein
the uncertainty is represented by a variance or a standard deviation indicating a variation in data.

6. The uncertainty learning device according to claim 1, the process further comprising:
to acquire prior data based on simulation data obtained by performing simulation operation on the machine device or the operation-related data related to the past operation result of the machine device; and
to train a prior learning model on a basis of prior training data created on a basis of the prior data acquired, wherein
the process creates the machine learning model by calculating a weighted loss function based on the outlier score calculated, and performing transfer learning on the prior learning model trained on a basis of the training data and the noise-imparted training data.

7. The uncertainty learning device according to claim 1, the process further comprising to acquire sensor data acquired by an external sensor disposed independently of the machine device, wherein
the process acquires the training data created on a basis of the operation-related data acquired from the machine device and the sensor data acquired.

8. The uncertainty learning device according to claim 1, the process further comprising:
to acquire prior data based on the operation result-related simulation data obtained by performing simulation operation on the machine device or the operation-related data related to the past operation result of the machine device;
to train a prior learning model on a basis of prior training data created on a basis of the prior data acquired; and
to acquire sensor data acquired by an external sensor disposed independently of the machine device, wherein
the process acquires the training data created on a basis of the operation-related data obtained from the machine device and the sensor data acquired, and
the process creates the machine learning model by calculating a weighted loss function based on the outlier score calculated, and performing transfer learning on the prior learning model trained on a basis of the training data and the noise-imparted training data.

9. The uncertainty learning device according to claim 1, wherein
the machine device is an FA device, and the operation-related data includes a command position, a command speed, a command acceleration, a feedback speed, a feedback acceleration, a current value, or a value obtained by measuring a deviation of a processing position.

10. A non-transitory, computer-readable storage medium storing an uncertainty learning program to create a machine learning model to receive, as an input, data based on operation-related data related to an operation result of a machine device and to output a predicted value corresponding to the operation-related data and uncertainty of the predicted value, the uncertainty learning program being used for causing a computer to function as:
a training data acquirer to acquire training data created on a basis of the operation-related data obtained from the machine device;
a noise imparter to create noise-imparted training data in which noise is imparted to the training data acquired by the training data acquirer;
an outlier detector to calculate an outlier score from the training data acquired by the training data acquirer and the noise-imparted training data created by the noise imparter; and
a model learner to calculate a weighted loss function based on the outlier score calculated by the outlier detector, and trains the machine learning model on a basis of the training data and the noise-imparted training data.

11. An uncertainty learning system comprising:
the uncertainty learning device according to claim 1; and
the machine device.
